(19) United States
(12) Patent Application Publication
(10) Pub. No.: US 2026/0343019 A1
(43) Pub. Date: Oct. 29, 2026

(54) EQUIVALENT INTRA MODE FOR NON-INTRA PREDICTED CODING BLOCKS

(71) Applicant: InterDigital CE Patent Holdings, SAS, Paris (FR)

(72) Inventors: Karam Naser, Mouazé (FR); Ya Chen, Rennes (FR); Kevin Reuzé, Rennes (FR); Thierry Dumas, Rennes (FR)

(73) Assignee: InterDigital CE Patent Holdings, SAS, Paris (FR)

(21) Appl. No.: 19/113,621

(22) PCT Filed: Oct. 11, 2023
(86) PCT No.: PCT/EP2023/078186

§ 371 Date: Mar. 20, 2025

(30) Foreign Application Priority Data
Oct. 11, 2022 (EP) 22306526.9

(51) Int. Cl. H04N 19/593; H04N 19/176

(52) U.S. Cl. CPC H04N 19/593; H04N 19/176

(57) ABSTRACT

A video decoding device may determine that a current block is coded in a non-directional intra prediction mode (e.g., an inter prediction mode, a cross component prediction mode, a palette mode, an intra block copy (IBC) mode, or an intra template matching prediction (IntraTMP) mode). The device may derive a directional intra prediction mode that corresponds to the non-directional intra prediction mode. The derived directional intra prediction mode may indicate a derived intra prediction direction. The device may decode the current block based at least in part on the derived directional intra prediction mode.

### CROSS-REFERENCE TO RELATED APPLICATIONS

This application claims the benefit of European Provisional Patent Application No. EP22306526.9, filed Oct. 11, 2022, the contents of which are hereby incorporated by reference herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for deriving an equivalent intra mode.

An example device (e.g., a video decoding device) may determine that a current block is coded in a non-directional intra prediction mode. The device may derive a directional intra prediction mode that corresponds to the non-directional intra prediction mode. The derived directional intra prediction mode may indicate a derived intra prediction direction. The device may decode the current block based at least in part on the derived directional intra prediction mode.

Similarly, an example device (e.g., a video encoding device) may identify a non-directional intra prediction mode for encoding a current block. The device may derive a directional intra prediction mode that corresponds to the non-directional intra prediction mode. The derived directional intra prediction mode may include a derived intra prediction direction. The device may encode the current block based at least in part on the derived directional intra prediction mode.

The device may obtain a prediction block of the current block using the non-directional intra prediction mode. The device may obtain a plurality of reconstructed samples in the prediction block. The directional intra prediction mode may be derived based on the plurality of reconstructed samples in the prediction block and a plurality of reconstructed neighboring samples of the current block.

The device may store the derived directional intra prediction mode. The device may use the derived directional intra prediction mode to generate a most probable mode (MPM) list for a neighboring prediction block. The device may determine a low-frequency non-separable transform (LFNST) transform set based on the derived directional intra prediction mode. The current block may be decoded/encoded based on the LFNST transform set. The device may determine a multi-transform selection (MTS) transform set based on the derived directional intra prediction mode. The current block may be decoded/encoded based on the MTS transform set.

Deriving the directional intra prediction mode may involve deriving the directional intra prediction mode based on a histogram of gradients associated with reconstructed pixels neighboring the current block. Deriving the directional intra prediction mode may involve testing a plurality of candidate directional intra prediction modes on reconstructed pixels neighboring the current block; and selecting the directional intra prediction mode from the plurality of candidate directional intra prediction modes based on the testing.

The device may obtain a prediction block of the current block using the non-directional intra prediction mode. The device may obtain a plurality of reconstructed samples in the prediction block. The device may obtain a plurality of probable prediction modes. The device may compute a plurality of predictions of the plurality of reconstructed samples in the prediction block based on the plurality of probable prediction modes. The device may compute, based on the plurality of reconstructed samples in the prediction block and the corresponding plurality of predictions, a plurality of prediction errors that correspond to the plurality of probable prediction modes. The device may select, among the plurality of probable prediction modes, the directional intra prediction mode based on the plurality of prediction errors.

The non-directional intra prediction mode may be an inter prediction mode, a cross component prediction mode, a palette mode, an intra block copy (IBC) mode, or an intra template matching prediction (IntraTMP) mode.

The device may select a low-frequency non-separable transform (LFNST) transform set based on the directional intra prediction mode. The device may perform inverse transform on a residual of the current block based on the LFNST transform set.

The device may select a multi-transform selection (MTS) transform set based on the directional intra prediction mode. The device may perform inverse transform on a residual of the current block based on the MTS transform set.

A video decoding device may include a processor configured to determine that a current block is coded in a non-intra prediction mode (e.g., not a direction intra prediction mode, a DC mode, or a planar mode). For example, the non-intra prediction mode may be one or more of an inter prediction mode, a cross component prediction mode, a palette mode, an intra block copy (IBC) mode, or an intra template matching prediction (IntraTMP) mode. An intra prediction mode that corresponds to the non-intra prediction mode may be derived. The current block may be decoded based at least in part on the derived intra prediction mode.

In an example, a prediction block of the current block may be obtained using the non-intra prediction mode The intra prediction mode that corresponds to the non-intra prediction mode may be derived based on the prediction block.

In an example, a prediction block of the current block may be obtained using the non-intra prediction mode. Reconstructed samples in the prediction block may be obtained. The intra prediction mode may be derived based on the reconstructed samples in the prediction block and reconstructed neighboring samples.

The intra prediction mode may be derived by applying a decoder-side intra mode derivation (DIMD) process to at least one of a reconstructed template of the current block (e.g., a template around the current block, template samples neighboring the current block), a prediction block of the current block obtained using the non-intra prediction mode, or a reconstructed template inside the prediction block. The intra prediction mode may be derived by applying a template-based intra mode derivation (TIMD) process to at least one of a reconstructed template of the current block, a prediction block of the current block obtained using the non-intra prediction mode, or a reconstructed template inside the prediction block.

In an example, a prediction block of the current block may be obtained using the non-intra prediction mode. Reconstructed samples in the prediction block may be obtained. Probable prediction modes may be obtained. Predictions of the reconstructed samples in the prediction block may be computed based on the probable prediction modes. Prediction errors that correspond to the probable prediction modes may be computed based on the reconstructed samples in the prediction block and the corresponding predictions. The intra prediction mode may be selected, from the probable prediction modes, based on the prediction errors. The intra prediction mode may be selected based on a determination that the prediction error that corresponds to the intra prediction mode is the smallest among the prediction errors.

In an example, a prediction block of the current block may be obtained using the non-intra prediction mode. Samples in the prediction block may be obtained. A directionality of the prediction block may be determined based on the samples in the prediction block. The intra prediction mode may be derived based on the determined directionality of the prediction block.

A video encoding device may include a processor configured to identify a non-intra prediction mode for encoding a current block. An intra prediction mode that corresponds to the non-intra prediction mode may be derived. The current block may be encoded based at least in part on the derived intra prediction mode.

### BRIEF DESCRIPTION OF THE DRAWINGS

Furthermore, like reference numerals in the figures indicate like elements, and wherein:

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a a system in which various aspects and examples can be implemented.

FIGS. 5A-C show example prediction modes and prediction directions.

FIG. 6 shows an example of a template of a current luminance and decoded reference samples of the template.

FIG. 7 shows neighboring reconstructed samples used, for example, for decoder-side intra mode derivation (DIMD) chroma mode.

FIG. 8 illustrates an example of a matrix weighted intra prediction (MIP) process.

FIG. 9 illustrates example locations of samples used in a cross-component linear model (CCLM) mode.

FIGS. 10A and 10B illustrate an example effect of a slope adjustment parameter.

FIG. 11 illustrates a spatial part of a convolutional filter.

FIG. 12 illustrates an example reference area for an intra block copy (IBC) when a coding tree unit (CTU) is coded.

FIG. 13 illustrates an example intra template matching search area.

FIG. 14 illustrates an example of a block coded in palette mode.

FIGS. 15A-D illustrate an example geometric partitioning mode (GPM) with inter and intra prediction.

FIG. 16 is a table of the positions of available neighboring blocks for intra prediction mode (IPM) candidate derivation based on the angle of GPM block boundary.

FIG. 17 illustrates an example region of interest (ROI).

FIG. 18 illustrates an example ROI.

FIG. 19 illustrates an example mapping of intra prediction modes to low frequency non-separable transform (LFNST) set index.

FIG. 20 illustrates example neighboring blocks used to derive a general most probably modes (MPM) list.

FIG. 21 illustrates an example of deriving an equivalent mode.

FIG. 22A illustrates an example DIMD process.

FIG. 22B illustrates an MIP equivalent mode derivation.

FIG. 23 illustrates example coding block split partitions.

FIG. 24 illustrates an example flow chart for decoding a current block.

FIG. 25 illustrates and example flow chart for encoding a current block.

### DETAILED DESCRIPTION

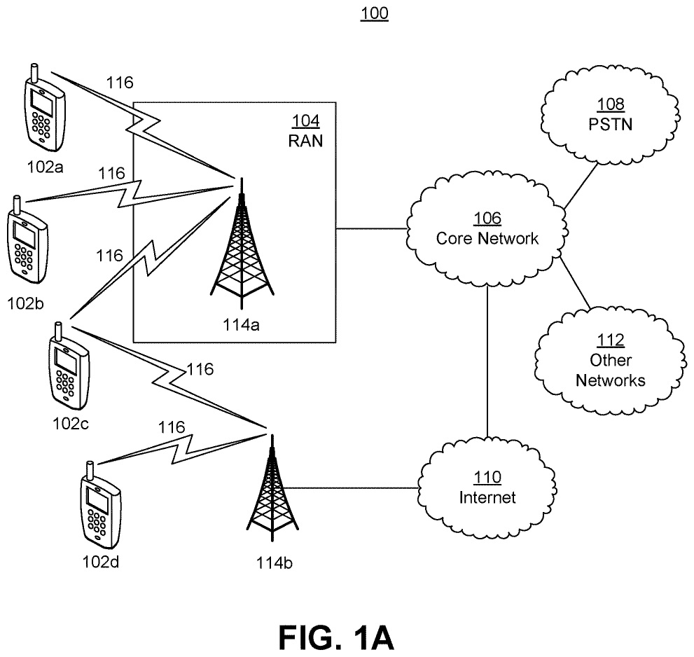

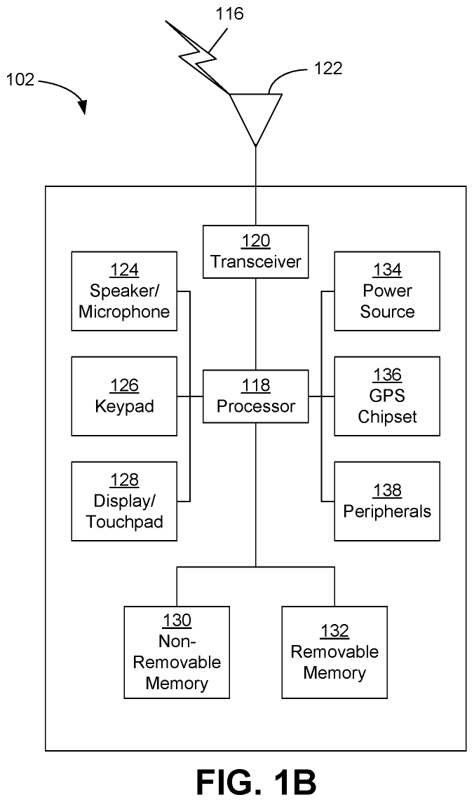

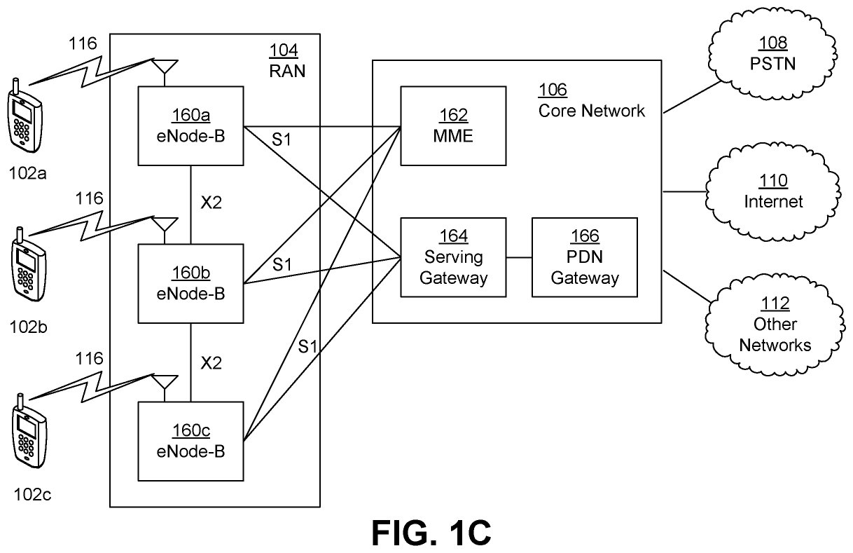

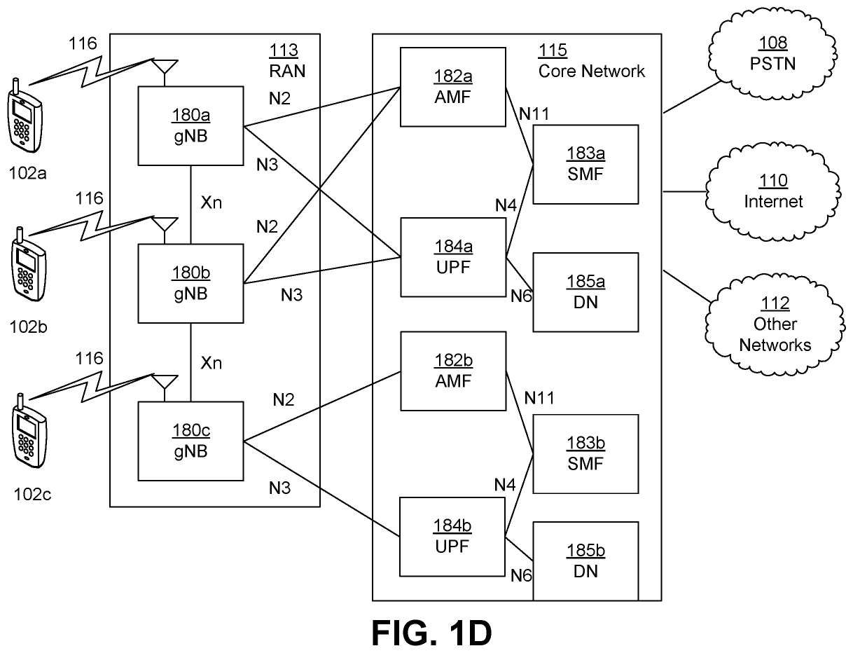

FIG. 1A is a diagram illustrating an example communications system 100 in which one or more disclosed embodiments can be implemented. The communications system 100 can be a multiple access system that provides content, such as voice, data, video, messaging, broadcast, etc., to multiple wireless users. The communications system 100 can enable multiple wireless users to access such content through the sharing of system resources, including wireless bandwidth. For example, the communications systems 100 can employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 can include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d can be any type of device configured to operate and/or communicate in a wireless environment. By way of example, the WTRUs 102a, 102b, 102c, 102d, any of which can be referred to as a “station” and/or a “STA”, can be configured to transmit and/or receive wireless signals and can include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d can be interchangeably referred to as a UE.

The communications systems 100 can also include a base station 114a and/or a base station 114b. Each of the base stations 114a, 114b can be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b can be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b can include any number of interconnected base stations and/or network elements.

The base station 114a can be part of the RAN 104/113, which can also include other base stations and/or network elements (not shown), such as a base station controller (BSC), a radio network controller (RNC), relay nodes, etc. The base station 114a and/or the base station 114b can be configured to transmit and/or receive wireless signals on one or more carrier frequencies, which can be referred to as a cell (not shown). These frequencies can be in licensed spectrum, unlicensed spectrum, or a combination of licensed and unlicensed spectrum. A cell can provide coverage for a wireless service to a specific geographical area that can be relatively fixed or that can change over time. The cell can further be divided into cell sectors. For example, the cell associated with the base station 114a can be divided into three sectors. Thus, in one embodiment, the base station 114a can include three transceivers, i.e., one for each sector of the cell. In an embodiment, the base station 114a can employ multiple-input multiple output (MIMO) technology and can utilize multiple transceivers for each sector of the cell. For example, beamforming can be used to transmit and/or receive signals in desired spatial directions.

The base stations 114a, 114b can communicate with one or more of the WTRUs 102a, 102b, 102c, 102d over an air interface 116, which can be any suitable wireless communication link (e.g., radio frequency (RF), microwave, centimeter wave, micrometer wave, infrared (IR), ultraviolet (UV), visible light, etc.). The air interface 116 can be established using any suitable radio access technology (RAT).

More specifically, as noted above, the communications system 100 can be a multiple access system and can employ one or more channel access schemes, such as CDMA, TDMA, FDMA, OFDMA, SC-FDMA, and the like. For example, the base station 114a in the RAN 104/113 and the WTRUs 102a, 102b, 102c can implement a radio technology such as Universal Mobile Telecommunications System (UMTS) Terrestrial Radio Access (UTRA), which can establish the air interface 115/116/117 using wideband CDMA (WCDMA). WCDMA can include communication protocols such as High-Speed Packet Access (HSPA) and/or Evolved HSPA (HSPA+). HSPA can include High-Speed Downlink (DL) Packet Access (HSDPA) and/or High-Speed UL Packet Access (HSUPA).

In an embodiment, the base station 114a and the WTRUs 102a, 102b, 102c can implement a radio technology such as Evolved UMTS Terrestrial Radio Access (E-UTRA), which can establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c can implement a radio technology such as NR Radio Access, which can establish the air interface 116 using New Radio (NR).

In an embodiment, the base station 114a and the WTRUs 102a, 102b, 102c can implement multiple radio access technologies. For example, the base station 114a and the WTRUs 102a, 102b, 102c can implement LTE radio access and NR radio access together, for instance using dual connectivity (DC) principles. Thus, the air interface utilized by WTRUs 102a, 102b, 102c can be characterized by multiple types of radio access technologies and/or transmissions sent to/from multiple types of base stations (e.g., a eNB and a gNB).

In other embodiments, the base station 114a and the WTRUs 102a, 102b, 102c can implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A can be a wireless router, Home Node B, Home eNode B, or access point, for example, and can utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d can implement a radio technology such as IEEE 802.11 to establish a wireless local area network (WLAN). In an embodiment, the base station 114b and the WTRUs 102c, 102d can implement a radio technology such as IEEE 802.15 to establish a wireless personal area network (WPAN). In yet another embodiment, the base station 114b and the WTRUs 102c, 102d can utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b can have a direct connection to the Internet 110. Thus, the base station 114b may not be required to access the Internet 110 via the CN 106/115.

The RAN 104/113 can be in communication with the CN 106/115, which can be any type of network configured to provide voice, data, applications, and/or voice over internet protocol (VoIP) services to one or more of the WTRUs 102a, 102b, 102c, 102d. The data can have varying quality of service (QoS) requirements, such as differing throughput requirements, latency requirements, error tolerance requirements, reliability requirements, data throughput requirements, mobility requirements, and the like. The CN 106/115 can provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 can be in direct or indirect communication with other RANs that employ the same RAT as the RAN 104/113 or a different RAT. For example, in addition to being connected to the RAN 104/113, which can be utilizing a NR radio technology, the CN 106/115 can also be in communication with another RAN (not shown) employing a GSM, UMTS, CDMA 2000, WiMAX, E-UTRA, or WiFi radio technology.

The CN 106/115 can also serve as a gateway for the WTRUs 102a, 102b, 102c, 102d to access the PSTN 108, the Internet 110, and/or the other networks 112. The PSTN 108 can include circuit-switched telephone networks that provide plain old telephone service (POTS). The Internet 110 can include a global system of interconnected computer networks and devices that use common communication protocols, such as the transmission control protocol (TCP), user datagram protocol (UDP) and/or the internet protocol (IP) in the TCP/IP internet protocol suite. The networks 112 can include wired and/or wireless communications networks owned and/or operated by other service providers. For example, the networks 112 can include another CN connected to one or more RANs, which can employ the same RAT as the RAN 104/113 or a different RAT.

Some or all of the WTRUs 102a, 102b, 102c, 102d in the communications system 100 can include multi-mode capabilities (e.g., the WTRUs 102a, 102b, 102c, 102d can include multiple transceivers for communicating with different wireless networks over different wireless links). For example, the WTRU 102c shown in FIG. 1A can be configured to communicate with the base station 114a, which can employ a cellular-based radio technology, and with the base station 114b, which can employ an IEEE 802 radio technology.

FIG. 1B is a system diagram illustrating an example WTRU 102. As shown in FIG. 1B, the WTRU 102 can include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 can include any sub-combination of the foregoing elements while remaining consistent with an embodiment.

The processor 118 can be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. As suggested above, the processor 118 can include a plurality of processors. The processor 118 can perform signal coding, data processing, power control, input/output processing, and/or any other functionality that enables the WTRU 102 to operate in a wireless environment. The processor 118 can be coupled to the transceiver 120, which can be coupled to the transmit/receive element 122. While FIG. 1B depicts the processor 118 and the transceiver 120 as separate components, it will be appreciated that the processor 118 and the transceiver 120 can be integrated together in an electronic package or chip.

The transmit/receive element 122 can be configured to transmit signals to, or receive signals from, a base station (e.g., the base station 114a) over the air interface 116. For example, in one embodiment, the transmit/receive element 122 can be an antenna configured to transmit and/or receive RF signals. In an embodiment, the transmit/receive element 122 can be an emitter/detector configured to transmit and/or receive IR, UV, or visible light signals, for example. In yet another embodiment, the transmit/receive element 122 can be configured to transmit and/or receive both RF and light signals. It will be appreciated that the transmit/receive element 122 can be configured to transmit and/or receive any combination of wireless signals.

Although the transmit/receive element 122 is depicted in FIG. 1B as a single element, the WTRU 102 can include any number of transmit/receive elements 122. More specifically, the WTRU 102 can employ MIMO technology. Thus, in one embodiment, the WTRU 102 can include two or more transmit/receive elements 122 (e.g., multiple antennas) for transmitting and receiving wireless signals over the air interface 116.

The transceiver 120 can be configured to modulate the signals that are to be transmitted by the transmit/receive element 122 and to demodulate the signals that are received by the transmit/receive element 122. As noted above, the WTRU 102 can have multi-mode capabilities. Thus, the transceiver 120 can include multiple transceivers for enabling the WTRU 102 to communicate via multiple RATs, such as NR and IEEE 802.11, for example.

The processor 118 of the WTRU 102 can be coupled to, and can receive user input data from, the speaker/microphone 124, the keypad 126, and/or the display/touchpad 128 (e.g., a liquid crystal display (LCD) display unit or organic light-emitting diode (OLED) display unit). The processor 118 can also output user data to the speaker/microphone 124, the keypad 126, and/or the display/touchpad 128. In addition, the processor 118 can access information from, and store data in, any type of suitable memory, such as the non-removable memory 130 and/or the removable memory 132. The non-removable memory 130 can include random-access memory (RAM), read-only memory (ROM), a hard disk, or any other type of memory storage device. The removable memory 132 can include a subscriber identity module (SIM) card, a memory stick, a secure digital (SD) memory card, and the like. In other embodiments, the processor 118 can access information from, and store data in, memory that is not physically located on the WTRU 102, such as on a server or a home computer (not shown).

The processor 118 can receive power from the power source 134, and can be configured to distribute and/or control the power to the other components in the WTRU 102. The power source 134 can be any suitable device for powering the WTRU 102. For example, the power source 134 can include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 can also be coupled to the GPS chipset 136, which can be configured to provide location information (e.g., longitude and latitude) regarding the current location of the WTRU 102. In addition to, or in lieu of, the information from the GPS chipset 136, the WTRU 102 can receive location information over the air interface 116 from a base station (e.g., base stations 114a, 114b) and/or determine its location based on the timing of the signals being received from two or more nearby base stations. It will be appreciated that the WTRU 102 can acquire location information by way of any suitable location-determination method while remaining consistent with an embodiment.

The processor 118 can further be coupled to other peripherals 138, which can include one or more software and/or hardware modules that provide additional features, functionality and/or wired or wireless connectivity. For example, the peripherals 138 can include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 can include one or more sensors, the sensors can be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 can include a full duplex radio for which transmission and reception of some or all of the signals (e.g., associated with particular subframes for both the UL (e.g., for transmission) and downlink (e.g., for reception) can be concurrent and/or simultaneous. The full duplex radio can include an interference management unit to reduce and or substantially eliminate self-interference via either hardware (e.g., a choke) or signal processing via a processor (e.g., a separate processor (not shown) or via processor 118). In an embodiment, the WRTU 102 can include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 can employ an E-UTRA radio technology to communicate with the WTRUs 102a, 102b, 102c over the air interface 116. The RAN 104 can also be in communication with the CN 106.

The RAN 104 can include eNode-Bs 160a, 160b, 160c, though it will be appreciated that the RAN 104 can include any number of eNode-Bs while remaining consistent with an embodiment. The eNode-Bs 160a, 160b, 160c can each include one or more transceivers for communicating with the WTRUs 102a, 102b, 102c over the air interface 116. In one embodiment, the eNode-Bs 160a, 160b, 160c can implement MIMO technology. Thus, the eNode-B 160a, for example, can use multiple antennas to transmit wireless signals to, and/or receive wireless signals from, the WTRU 102a.

Each of the eNode-Bs 160a, 160b, 160c can be associated with a particular cell (not shown) and can be configured to handle radio resource management decisions, handover decisions, scheduling of users in the UL and/or DL, and the like. As shown in FIG. 1C, the eNode-Bs 160a, 160b, 160c can communicate with one another over an X2 interface.

The CN 106 shown in FIG. 1C can include a mobility management entity (MME) 162, a serving gateway (SGW) 164, and a packet data network (PDN) gateway (or PGW) 166. While each of the foregoing elements are depicted as part of the CN 106, it will be appreciated that any of these elements can be owned and/or operated by an entity other than the CN operator.

The MME 162 can be connected to each of the eNode-Bs 162a, 162b, 162c in the RAN 104 via an S1 interface and can serve as a control node. For example, the MME 162 can be responsible for authenticating users of the WTRUs 102a, 102b, 102c, bearer activation/deactivation, selecting a particular serving gateway during an initial attach of the WTRUs 102a, 102b, 102c, and the like. The MME 162 can provide a control plane function for switching between the RAN 104 and other RANs (not shown) that employ other radio technologies, such as GSM and/or WCDMA.

The SGW 164 can be connected to each of the eNode Bs 160a, 160b, 160c in the RAN 104 via the S1 interface. The SGW 164 can generally route and forward user data packets to/from the WTRUs 102a, 102b, 102c. The SGW 164 can perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 can be connected to the PGW 166, which can provide the WTRUs 102a, 102b, 102c with access to packet-switched networks, such as the Internet 110, to facilitate communications between the WTRUs 102a, 102b, 102c and IP-enabled devices.

The CN 106 can facilitate communications with other networks. For example, the CN 106 can provide the WTRUs 102a, 102b, 102c with access to circuit-switched networks, such as the PSTN 108, to facilitate communications between the WTRUs 102a, 102b, 102c and traditional land-line communications devices. For example, the CN 106 can include, or can communicate with, an IP gateway (e.g., an IP multimedia subsystem (IMS) server) that serves as an interface between the CN 106 and the PSTN 108. In addition, the CN 106 can provide the WTRUs 102a, 102b, 102c with access to the other networks 112, which can include other wired and/or wireless networks that are owned and/or operated by other service providers.

Although the WTRU is described in FIGS. 1A-1D as a wireless terminal, it is contemplated that in certain representative embodiments that such a terminal can use (e.g., temporarily or permanently) wired communication interfaces with the communication network.

In representative embodiments, the other network 112 can be a WLAN.

A WLAN in Infrastructure Basic Service Set (BSS) mode can have an Access Point (AP) for the BSS and one or more stations (STAs) associated with the AP. The AP can have an access or an interface to a Distribution System (DS) or another type of wired/wireless network that carries traffic in to and/or out of the BSS. Traffic to STAs that originates from outside the BSS can arrive through the AP and can be delivered to the STAs. Traffic originating from STAs to destinations outside the BSS can be sent to the AP to be delivered to respective destinations. Traffic between STAs within the BSS can be sent through the AP, for example, where the source STA can send traffic to the AP and the AP can deliver the traffic to the destination STA. The traffic between STAs within a BSS can be considered and/or referred to as peer-to-peer traffic. The peer-to-peer traffic can be sent between (e.g., directly between) the source and destination STAs with a direct link setup (DLS). In certain representative embodiments, the DLS can use an 802.11e DLS or an 802.11z tunneled DLS (TDLS). A WLAN using an Independent BSS (IBSS) mode may not have an AP, and the STAs (e.g., all of the STAs) within or using the IBSS can communicate directly with each other. The IBSS mode of communication can sometimes be referred to herein as an “ad-hoc” mode of communication.

When using the 802.11ac infrastructure mode of operation or a similar mode of operations, the AP can transmit a beacon on a fixed channel, such as a primary channel. The primary channel can be a fixed width (e.g., 20 MHz wide bandwidth) or a dynamically set width via signaling. The primary channel can be the operating channel of the BSS and can be used by the STAs to establish a connection with the AP. In certain representative embodiments, Carrier Sense Multiple Access with Collision Avoidance (CSMA/CA) can be implemented, for example in in 802.11 systems. For CSMA/CA, the STAs (e.g., every STA), including the AP, can sense the primary channel. If the primary channel is sensed/detected and/or determined to be busy by a particular STA, the particular STA can back off. One STA (e.g., only one station) can transmit at any given time in a given BSS.

High Throughput (HT) STAs can use a 40 MHz wide channel for communication, for example, via a combination of the primary 20 MHz channel with an adjacent or nonadjacent 20 MHz channel to form a 40 MHz wide channel.

Very High Throughput (VHT) STAs can support 20 MHz, 40 MHz, 80 MHz, and/or 160 MHz wide channels. The 40 MHz, and/or 80 MHz, channels can be formed by combining contiguous 20 MHz channels. A 160 MHz channel can be formed by combining 8 contiguous 20 MHz channels, or by combining two non-contiguous 80 MHz channels, which can be referred to as an 80+80 configuration. For the 80+80 configuration, the data, after channel encoding, can be passed through a segment parser that can divide the data into two streams. Inverse Fast Fourier Transform (IFFT) processing, and time domain processing, can be done on each stream separately. The streams can be mapped on to the two 80 MHz channels, and the data can be transmitted by a transmitting STA. At the receiver of the receiving STA, the above described operation for the 80+80 configuration can be reversed, and the combined data can be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah can support Meter Type Control/Machine-Type Communications, such as MTC devices in a macro coverage area. MTC devices can have certain capabilities, for example, limited capabilities including support for (e.g., only support for) certain and/or limited bandwidths. The MTC devices can include a battery with a battery life above a threshold (e.g., to maintain a very long battery life).

WLAN systems, which can support multiple channels, and channel bandwidths, such as 802.11n, 802.11ac, 802.11af, and 802.11ah, include a channel which can be designated as the primary channel. The primary channel can have a bandwidth equal to the largest common operating bandwidth supported by all STAs in the BSS. The bandwidth of the primary channel can be set and/or limited by a STA, from among all STAs in operating in a BSS, which supports the smallest bandwidth operating mode. In the example of 802.11ah, the primary channel can be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings can depend on the status of the primary channel. If the primary channel is busy, for example, due to a STA (which supports only a 1 MHz operating mode), transmitting to the AP, the entire available frequency bands can be considered busy even though a majority of the frequency bands remains idle and can be available.

In the United States, the available frequency bands, which can be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 can employ an NR radio technology to communicate with the WTRUs 102a, 102b, 102c over the air interface 116. The RAN 113 can also be in communication with the CN 115.

The RAN 113 can include gNBs 180a, 180b, 180c, though it will be appreciated that the RAN 113 can include any number of gNBs while remaining consistent with an embodiment. The gNBs 180a, 180b, 180c can each include one or more transceivers for communicating with the WTRUs 102a, 102b, 102c over the air interface 116. In one embodiment, the gNBs 180a, 180b, 180c can implement MIMO technology. For example, gNBs 180a, 108b can utilize beamforming to transmit signals to and/or receive signals from the gNBs 180a, 180b, 180c. Thus, the gNB 180a, for example, can use multiple antennas to transmit wireless signals to, and/or receive wireless signals from, the WTRU 102a. In an embodiment, the gNBs 180a, 180b, 180c can implement carrier aggregation technology. For example, the gNB 180a can transmit multiple component carriers to the WTRU 102a (not shown). A subset of these component carriers can be on unlicensed spectrum while the remaining component carriers can be on licensed spectrum. In an embodiment, the gNBs 180a, 180b, 180c can implement Coordinated Multi-Point (COMP) technology. For example, WTRU 102a can receive coordinated transmissions from gNB 180a and gNB 180b (and/or gNB 180c).

The WTRUs 102a, 102b, 102c can communicate with gNBs 180a, 180b, 180c using transmissions associated with a scalable numerology. For example, the OFDM symbol spacing and/or OFDM subcarrier spacing can vary for different transmissions, different cells, and/or different portions of the wireless transmission spectrum. The WTRUs 102a, 102b, 102c can communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c can be configured to communicate with the WTRUs 102a, 102b, 102c in a standalone configuration and/or a non-standalone configuration. In the standalone configuration, WTRUs 102a, 102b, 102c can communicate with gNBs 180a, 180b, 180c without also accessing other RANs (e.g., such as eNode-Bs 160a, 160b, 160c). In the standalone configuration, WTRUs 102a, 102b, 102c can utilize one or more of gNBs 180a, 180b, 180c as a mobility anchor point. In the standalone configuration, WTRUs 102a, 102b, 102c can communicate with gNBs 180a, 180b, 180c using signals in an unlicensed band. In a non-standalone configuration WTRUs 102a, 102b, 102c can communicate with/connect to gNBs 180a, 180b, 180c while also communicating with/connecting to another RAN such as eNode-Bs 160a, 160b, 160c. For example, WTRUs 102a, 102b, 102c can implement DC principles to communicate with one or more gNBs 180a, 180b, 180c and one or more eNode-Bs 160a, 160b, 160c substantially simultaneously. In the non-standalone configuration, eNode-Bs 160a, 160b, 160c can serve as a mobility anchor for WTRUs 102a, 102b, 102c and gNBs 180a, 180b, 180c can provide additional coverage and/or throughput for servicing WTRUs 102a, 102b, 102c.

Each of the gNBs 180a, 180b, 180c can be associated with a particular cell (not shown) and can be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c can communicate with one another over an Xn interface.

The CN 115 shown in FIG. 1D can include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements can be owned and/or operated by an entity other than the CN operator.

The AMF 182a, 182b can be connected to one or more of the gNBs 180a, 180b, 180c in the RAN 113 via an N2 interface and can serve as a control node. For example, the AMF 182a, 182b can be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing can be used by the AMF 182a, 182b in order to customize CN support for WTRUs 102a, 102b, 102c based on the types of services being utilized WTRUs 102a, 102b, 102c. For example, different network slices can be established for different use cases such as services relying on ultra-reliable low latency (URLLC) access, services relying on enhanced massive mobile broadband (eMBB) access, services for machine type communication (MTC) access, and/or the like. The AMF 162 can provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b can be connected to an AMF 182a, 182b in the CN 115 via an N11 interface. The SMF 183a, 183b can also be connected to a UPF 184a, 184b in the CN 115 via an N4 interface. The SMF 183a, 183b can select and control the UPF 184a, 184b and configure the routing of traffic through the UPF 184a, 184b. The SMF 183a, 183b can perform other functions, such as managing and allocating UE IP address, managing PDU sessions, controlling policy enforcement and QoS, providing downlink data notifications, and the like. A PDU session type can be IP-based, non-IP based, Ethernet-based, and the like.

The UPF 184a, 184b can be connected to one or more of the gNBs 180a, 180b, 180c in the RAN 113 via an N3 interface, which can provide the WTRUs 102a, 102b, 102c with access to packet-switched networks, such as the Internet 110, to facilitate communications between the WTRUs 102a, 102b, 102c and IP-enabled devices. The UPF 184, 184b can perform other functions, such as routing and forwarding packets, enforcing user plane policies, supporting multi-homed PDU sessions, handling user plane QoS, buffering downlink packets, providing mobility anchoring, and the like.

The CN 115 can facilitate communications with other networks. For example, the CN 115 can include, or can communicate with, an IP gateway (e.g., an IP multimedia subsystem (IMS) server) that serves as an interface between the CN 115 and the PSTN 108. In addition, the CN 115 can provide the WTRUs 102a, 102b, 102c with access to the other networks 112, which can include other wired and/or wireless networks that are owned and/or operated by other service providers. In one embodiment, the WTRUs 102a, 102b, 102c can be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, can be performed by one or more emulation devices (not shown). The emulation devices can be one or more devices configured to emulate one or more, or all, of the functions described herein. For example, the emulation devices can be used to test other devices and/or to simulate network and/or WTRU functions.

The emulation devices can be designed to implement one or more tests of other devices in a lab environment and/or in an operator network environment. For example, the one or more emulation devices can perform the one or more, or all, functions while being fully or partially implemented and/or deployed as part of a wired and/or wireless communication network in order to test other devices within the communication network. The one or more emulation devices can perform the one or more, or all, functions while being temporarily implemented/deployed as part of a wired and/or wireless communication network. The emulation device can be directly coupled to another device for purposes of testing and/or can performing testing using over-the-air wireless communications.

The one or more emulation devices can perform the one or more, including all, functions while not being implemented/deployed as part of a wired and/or wireless communication network. For example, the emulation devices can be utilized in a testing scenario in a testing laboratory and/or a non-deployed (e.g., testing) wired and/or wireless communication network in order to implement testing of one or more components. The one or more emulation devices can be test equipment. Direct RF coupling and/or wireless communications via RF circuitry (e.g., which can include one or more antennas) can be used by the emulation devices to transmit and/or receive data.

This application describes a variety of aspects, including tools, features, examples, models, approaches, etc. Many of these aspects are described with specificity and, at least to show the individual characteristics, are often described in a manner that can sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

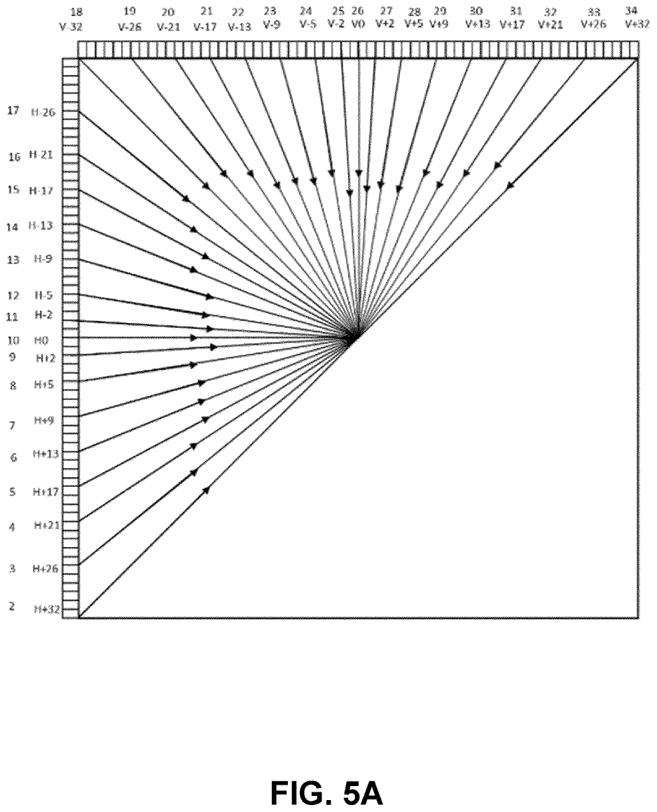

The aspects described and contemplated in this application can be implemented in many different forms. FIGS. 5-25 described herein can provide some examples, but other examples are contemplated. The discussion of FIGS. 5-25 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” can be used interchangeably, the terms “pixel” and “sample” can be used interchangeably, the terms “image,” “picture” and “frame” can be used interchangeably.

Various methods are described herein, and each of the methods comprises one or more steps or actions for achieving the described method. Unless a specific order of steps or actions is required for proper operation of the method, the order and/or use of specific steps and/or actions can be modified or combined. Additionally, terms such as “first”, “second”, etc. can be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and can occur, for example, before, during, or in an overlapping time period with the second decoding.

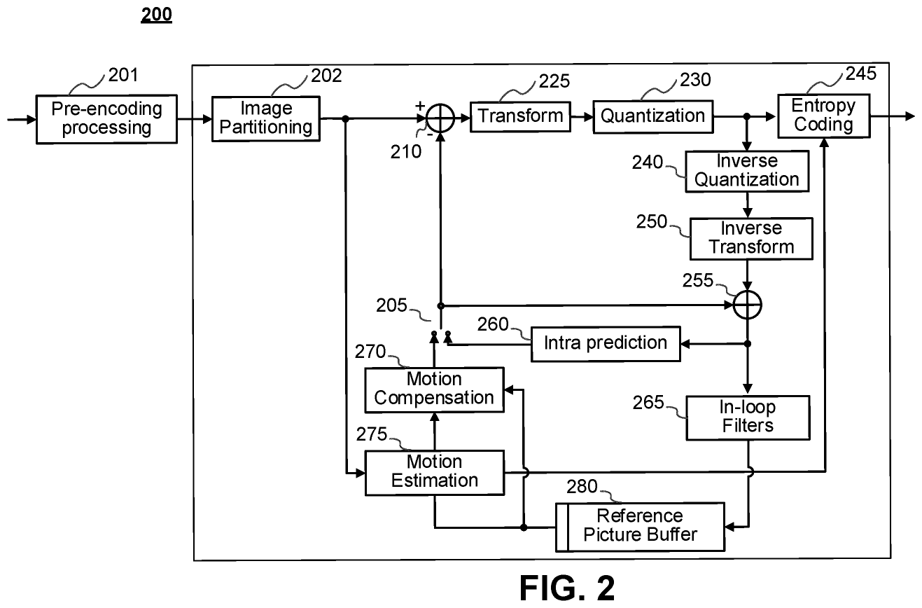

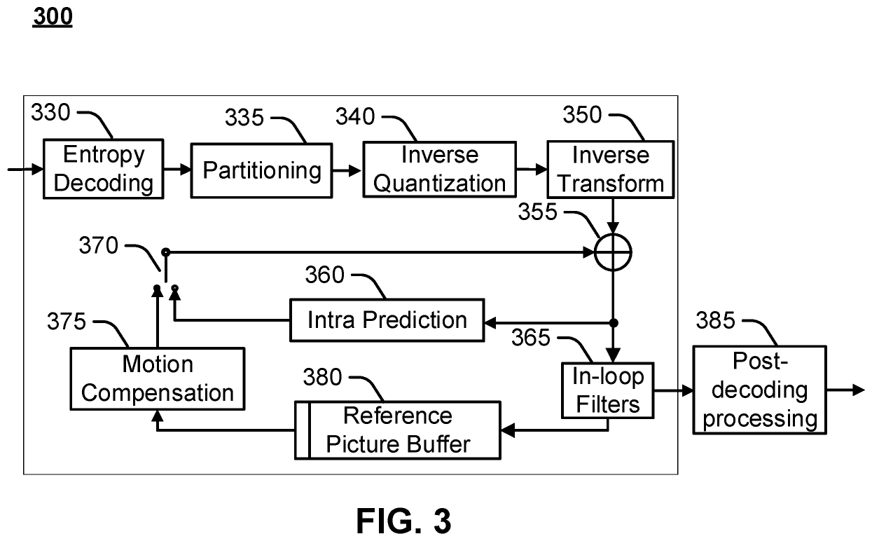

Various methods and other aspects described in this application can be used to modify modules, for example, decoding modules, of a video encoder 200 and decoder 300 as shown in FIG. 2 and FIG. 3. Moreover, the subject matter disclosed herein can be applied, for example, to any type, format or version of video coding, whether described in a standard or a recommendation, whether pre-existing or future-developed, and extensions of any such standards and recommendations. Unless indicated otherwise, or technically precluded, the aspects described in this application can be used individually or in combination.

Various numeric values are used in examples described the present application, such as bits, bit depth, etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence can go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder can therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) can be sent to a display device for rendering to a user.

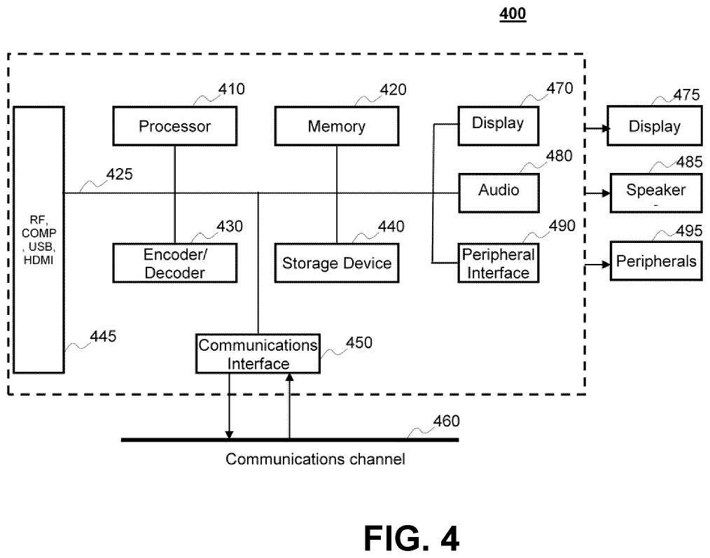

FIG. 4 is a diagram showing an example of a system in which various aspects and examples described herein can be implemented. System 400 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, can be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that can be included in a device to perform the encoding and/or decoding functions. As is known, a device can include one or both of the encoding and decoding modules. Additionally, encoder/decoder module 430 can be implemented as a separate element of system 400 or can be incorporated within processor 410 as a combination of hardware and software as known to those skilled in the art.

Program code to be loaded onto processor 410 or encoder/decoder 430 to perform the various aspects described in this document can be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device can be either the processor 410 or the encoder/decoder module 430) is used for one or more of these functions. The external memory can be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 can be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain examples, (iv) demodulating the down-converted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, down-converting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, can be implemented, for example, within a separate input processing IC or within processor 410 as necessary. Similarly, aspects of USB or HDMI interface processing can be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 can be provided within an integrated housing, Within the integrated housing, the various elements can be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 can be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 can be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices can be communicatively coupled to system 400 via dedicated connections through respective interfaces 470, 480, and 490. Alternatively, the output devices can be connected to system 400 using the communications channel 460 via the communications interface 450. The display 475 and speakers 485 can be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal can be provided via dedicated output connections, including, for example, HDMI ports, USB ports, or COMP outputs.

The examples can be carried out by computer software implemented by the processor 410 or by hardware, or by a combination of hardware and software. As a non-limiting example, the examples can be implemented by one or more integrated circuits. The memory 420 can be of any type appropriate to the technical environment and can be implemented using any appropriate data storage technology, such as optical memory devices, magnetic memory devices, semiconductor-based memory devices, fixed memory, and removable memory, as non-limiting examples. The processor 410 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, determining that a current block is coded in a non-directional intra prediction mode; deriving a directional intra prediction mode that corresponds to the non-directional intra prediction mode, wherein the derived directional intra prediction mode indicates a derived intra prediction direction; and decoding the current block based at least in part on the derived directional intra prediction mode, etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, identifying a non-directional intra prediction mode for encoding a current block; deriving a directional intra prediction mode that corresponds to the non-directional intra prediction mode, wherein the derived directional intra prediction mode comprises a derived intra prediction direction; and encoding the current block based at least in part on the derived directional intra prediction mode, etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application can refer to “determining” various pieces of information. Determining the information can include one or more of, for example, estimating the information, calculating the information, predicting the information, or retrieving the information from memory. Obtaining can include receiving, retrieving, constructing, generating, and/or determining.

Further, this application can refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application can refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as is clear to one of ordinary skill in this and related arts, for as many items as are listed.

Also, as used herein, the word “signal” refers to, among other things, indicating something to a corresponding decoder. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various examples. It is to be appreciated that signaling can be accomplished in a variety of ways. For example, one or more syntax elements, flags, and so forth are used to signal information to a corresponding decoder in various examples. While the preceding relates to the verb form of the word “signal”, the word “signal” can (e.g., can also) be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described example. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on, or accessed or received from, a processor-readable medium.

Many examples are described herein. Features of examples can be provided alone or in any combination, across various claim categories and types. Further, examples can include one or more of the features, devices, or aspects described herein, alone or in any combination, across various claim categories and types. For example, features described herein can be implemented in a bitstream or signal that includes information generated as described herein. The information can allow a decoder to decode a bitstream, the encoder, bitstream, and/or decoder according to any of the embodiments described. For example, features described herein can be implemented by creating and/or transmitting and/or receiving and/or decoding a bitstream or signal. For example, features described herein can be implemented a method, process, apparatus, medium storing instructions, medium storing data, or signal. For example, features described herein can be implemented by a TV, set-top box, cell phone, tablet, or other electronic device that performs decoding. The TV, set-top box, cell phone, tablet, or other electronic device can display (e.g., using a monitor, screen, or other type of display) a resulting image (e.g., an image from residual reconstruction of the video bitstream). The TV, set-top box, cell phone, tablet, or other electronic device can receive a signal including an encoded image and perform decoding.

These examples can be performed by a device with at least one processor. The device can be an encoder or a decoder. These examples can be performed by a computer program product which is stored on a non-transitory computer readable medium and includes program code instructions. These examples can be performed by a computer program comprising program code instructions. These examples can be performed by a bitstream comprising information representative of the coding block.

Intra sample prediction may include predicting pixels of a target coding unit (CU) based on a set of reference samples. Prediction modes may include planar and DC prediction modes, which may be used to predict smooth and gradually changing regions. Angular prediction modes (e.g., an angle defined from 45 degrees to −135 degrees in a clockwise direction) may be used to capture different directional structures. For square blocks, directional prediction modes (e.g., 33 directional modes for square blocks), which may be indexed (e.g., indexed from 2 to 34), may be used. The prediction modes may correspond to different prediction directions as illustrated in FIG. 5A. Angular prediction modes may correspond to angular directions (e.g., 65 angular prediction modes may correspond to 33 angular directions), and angular directions (e.g., a further 32 angular directions) may correspond to a direction mid-way between an adjacent pair as illustrated in FIG. 5B.

FIG. 5A illustrates example intra prediction directions. A number may denote the prediction mode index associated with the corresponding direction. The modes 2 through 17 may indicate horizontal predictions (H−26 to H+32), and the modes 18 through 34 may indicate vertical predictions (V−32 to V+32). The FIG. 5B illustrates intra prediction for square blocks (e.g., for square blocks). Modes less than 34 may indicate horizontal predictions. Modes greater than 34 may indicate vertical predictions. FIG. 5C illustrates available (e.g., all available) intra prediction directions. Dashed lines may indicate wide angle intra prediction modes (WAIP). The indices −1 through −14 illustrated in FIG. 5C may be remapped to go from 1 through −12 (e.g., such that angular mode indices are continuous). Modes −15 (e.g., remapped to −13) and 81 may not be present in FIG. 5C, as block sizes (e.g., no allowed block sizes) may not use modes −15 (e.g., remapped to −13) and 81. Modes −15 (e.g., remapped to −13) and 81 may be handled by reference code.

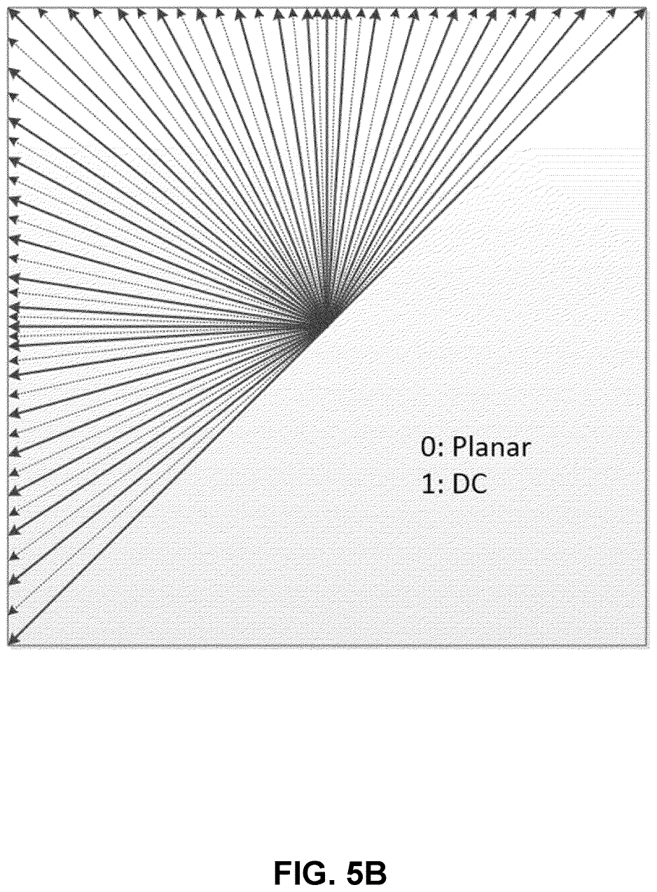

Template-based intra mode derivation (TIMD) may be performed to derive prediction mode(s) for a coding block. Intra prediction mode derivation via TIMD may be applied (e.g., the same way) on encoder and decoder sides for a given luminance, such as CB 603 shown in FIG. 6(a). An (e.g., each) intra prediction mode (e.g., supplemented with default modes) in a most probable mode (MPM) list of the luminance CB may be used to compute a prediction of the template (600 and 601) of the luminance CB from the decoded reference samples of the template (602). The sum of absolute transformed differences (SATD) between the prediction and the template of the luminance CB may be calculated. The (e.g., two) intra prediction mode(s) with the minimum (e.g., smallest) SATDs may be selected as the TIMD mode(s). The set of directional intra prediction modes (e.g., for TIMD) may be extended (e.g., from 65 to 129), for example, by inserting a direction between each solid and neighboring dashed arrow in FIG. 5B. The set of possible intra prediction modes derived via TIMD may gather modes (e.g., 131 modes). One or more (e.g., two) intra prediction modes may be retained from the first pass of tests involving the MPM list may be supplemented with default modes. For each retained intra prediction mode that is not PLANAR or DC, (e.g., two) closest extended directional intra prediction mode(s) may be tested. The SATD(s) between the prediction computed using the closest extended directional intra prediction mode(s) and the template of the luminance CB may be calculated. The intra prediction mode(s) with the minimum (e.g., smallest) SATDs may be selected as the TIMD mode(s).

FIG. 6 illustrates an example template of the current luminance CB and example decoded reference samples of the template used in TIMD. In FIG. 6(a), the template of the luminance CB does not go out of the bounds of the current frame. The current W×H luminance CB 603 may be surrounded by its fully available template, made of a wₜ×H portion on its left side at 600 and a W×hₜ portion above it at 601. During the TIMD derivation step, a tested intra prediction mode may predict the template of the current luminance CB from the set of 1+2wₜ+2W+2hₜ+2H decoded reference samples 602 of the template. wₜ may equal two if W≤8; otherwise, wₜ may equal four. hₜ may equal two if H≤8; otherwise hₜ may equal four.

FIGS. 6(b) and 6(c) show examples where at least a (e.g., one) portion of the template of the luminance CB goes out of the bounds of the current frame. In FIG. 6(b), the current W×H luminance CB 603 may be surrounded by its template with its W×hₜ portion above it at 601 available. During the TIMD derivation step, a tested intra prediction mode may predict the template of the current luminance CB from the set of 1+2W+2hₜ+2H decoded reference samples at 602 of the template. In FIG. 6(c), the current W×H luminance CB 603 may be surrounded by its template with only its w×H portion on its left side at 600 available. During the TIMD derivation step, a tested intra prediction mode many predict the template of the current luminance CB from the set of 1+2wₜ+2W+2H decoded reference samples at 602 of the template.

The current luminance CB may be predicted via TIMD, for example, by fusing the (e.g., two) predictions of the luminance CB computed based on the (e.g., two) TIMD modes resulting from the (e.g., two) passes of tests with weights (e.g., after applying position dependent prediction combination (PDPC)). The weights used may depend on the prediction SATDs of the (e.g., two) TIMD modes.

Decoder side intra mode derivation (DIMD) may be performed to derive intra prediction mode(s) for a coding block. For example, two intra modes may be derived from the reconstructed neighbor samples. The two predictors may be combined with the planar mode predictor with the weights derived from gradients. The division operations in weight derivation may be performed utilizing the same lookup table (LUT) based integerization scheme used by the cross-complaint linear model (CCLM). For example, the division operation in the orientation calculation

Orient=G_{y}/Gₓ

may be computed by the following LUT-based scheme:

x=Floor (Log2(Gx))

norm Diff=((Gx<<4)>>x) & 15

X+=(3+(normDiff!=0)?1:0)

Orient=(Gy*(DivSigTable[normDiff]|8)+(1<<(x−1)))>>x,

where

DivSigTable[16]={0,7,6,5,5,4,4,3,3,2,2,1,1,1,1,0}.

Derived intra modes may be included in the primary list of intra MPM list. The DIMD process may be performed before the MPM list is constructed. The primary derived intra mode of a DIMD block may be stored with a block and may be used for MPM list construction of the neighboring blocks.

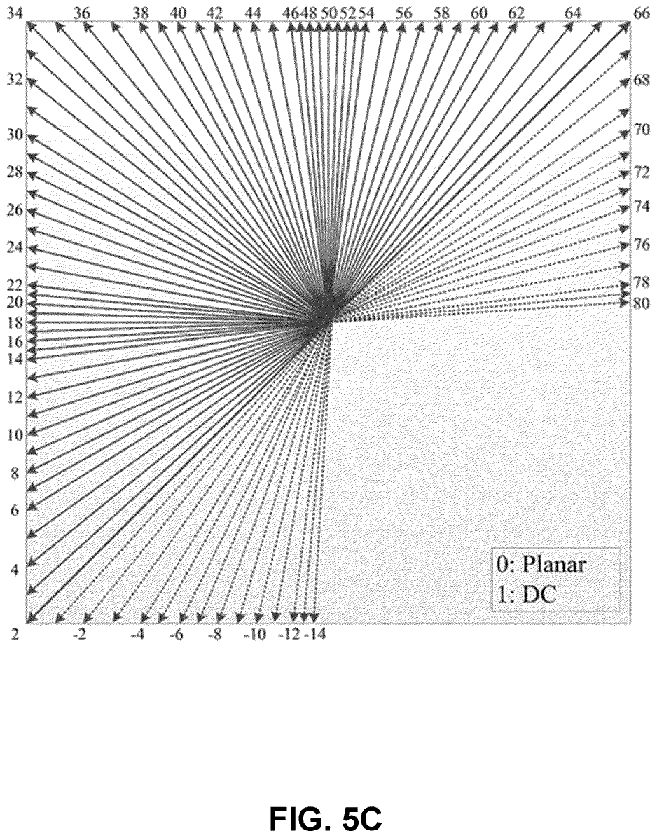

FIG. 7 illustrates neighboring reconstructed samples used for DIMD chroma mode. The DIMD chroma mode may use DIMD derivation to derive the chroma intra prediction mode of the current block based on the neighboring reconstructed Y, Cb, and Cr samples in the second neighboring row and column, as shown in FIG. 7. A horizontal gradient and a vertical gradient may be calculated for a collocated reconstructed luma sample (e.g., each collocated reconstructed luma sample) of the current chroma block, as well as the reconstructed Cb and Cr samples, to build a histogram of oriented gradients (HoG). The intra prediction mode with the largest histogram amplitude values may be used for performing chroma intra prediction of the current chroma block.

When the intra prediction mode derived from the DIMD chroma mode is the same as the intra prediction mode derived from the direct mode (DM), the intra prediction mode with the second largest histogram amplitude value may be used as the DIMD chroma mode. A CU level indication (e.g., flag) may be signaled to indicate whether the DIMD chroma mode is applied.

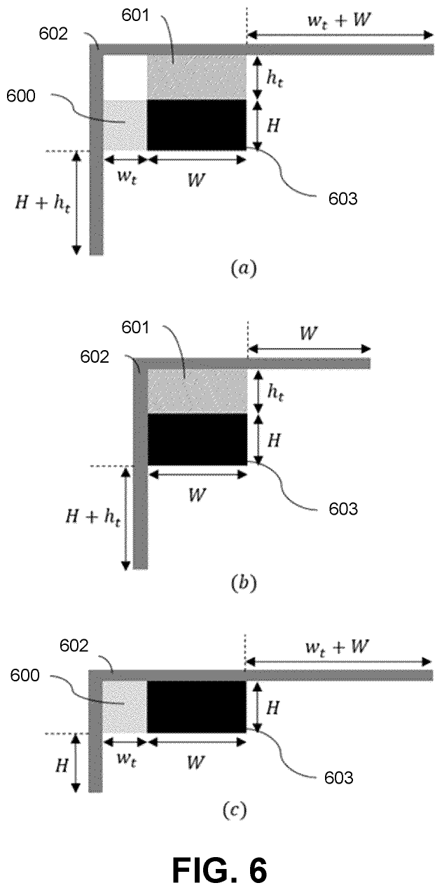

FIG. 8 illustrates an example of a matrix weighted intra prediction (MIP) process. For predicting the samples of a rectangular block of width W and height H, MIP may take one line of H reconstructed neighboring boundary samples left of the block and one line of W reconstructed neighboring boundary samples above the block as input. If the reconstructed samples are unavailable, they may be generated in the same or a similar manner as in other intra prediction examples (e.g., conventional intra prediction). The generation of the prediction signal may be based on at least the following three steps: averaging; matrix vector multiplication; and linear interpolation (e.g., as shown in FIG. 8).

CCLM may be performed to predict a coding block. A CCLM prediction mode may be used in video coding, for example, to reduce cross-component redundancy. Chroma samples may be predicted based on reconstructed luma samples (e.g., for the same CU), for example, by using a linear model. A linear model may be constructed, for example, in accordance with Eq. 1:

pred_{C}(i,j)=a·rec_{L}′(i,j)+β Eq.1

As shown by example in Eq. 1, pred_{C}(i,j) may represent predicted chroma samples in a CU. As shown by example in Eq. 1, rec_{L}′(i,j) may represent downsampled reconstructed luma samples of the (e.g., same) CU.

CCLM parameters (e.g., α and β) may be derived, for example, based on/using (e.g., at most four) neighboring chroma samples and corresponding down-sampled luma samples. To describe examples, assume current chroma block dimensions are W×H. In some examples, W″ and H′ may be set in accordance with the following logic:

W′=W,H′=H, for example, if/when LM mode is applied;

W′=W+H, for example, if/when LM-A mode is applied; and/or

H′=H+W, for example, if/when LM-L mode is applied.

In further discussion of examples, the above neighboring positions may be denoted as S[0,−1] . . . . S[W′−1,−1] and the left neighbouring positions may be denoted as S[−1, 0] . . . . S[−1, H′−1]. The four samples may be selected (e.g., in accordance with the example logic), as follows:
S[W′/4,−1], S[3*W/4,−1], S[−1, H′/4], S[−1, 3*H′/4], for example, if/when LM mode is applied and both above and left neighboring samples are available;
S[W′/8,−1], S[3*W′/8,−1], S[5*W′/8,−1], S[7*W′/8,−1], for example, if/when LM-A mode is applied or only the above neighboring samples are available; and/or
S[−1, H′/8], S[−1, 3*H′/8], S[−1, 5*H′/8], S[−1, 7*H′/8], for example, if/when LM-L mode is applied or only the left neighboring samples are available.

In examples, the four neighboring luma samples at the selected positions may be down-sampled and compared (e.g., four times) to find (e.g., two) larger values (e.g., denoted as x⁰_{A} and x¹_{A}) and (e.g., two) smaller values (e.g., denoted as x⁰_{B} and x¹_{B}). Corresponding chroma sample values may be denoted as y⁰_{A}, y¹_{A}, y⁰_{B} and y¹_{B}. In examples, x_{A}, x_{B}, y_{A} and y_{B} may be derived, for example, in accordance with Eq. 2a-2d:

Xₐ=(x⁰_{A}+x¹_{A}+1)>>1 Eq. 2a

X_{b}=(x⁰_{B}+x¹_{B}+1)>>1 Eq. 2b

Yₐ=(y⁰_{A}+y⁰_{A}+1)>>1 Eq. 2c

Y_{b}=(y⁰_{B}+y¹_{B}+1)>>1 Eq. 2d

Linear model parameters α and β may be determined, for example, in accordance with Eq. 3 and Eq. 4:

$$α = \frac{{Y}_{a} - {Y}_{b}}{{X}_{a} - {X}_{b}} \qquad Eq . 3$$

$$β = {Y}_{b} - α \cdot {X}_{b} \qquad Eq . 4$$

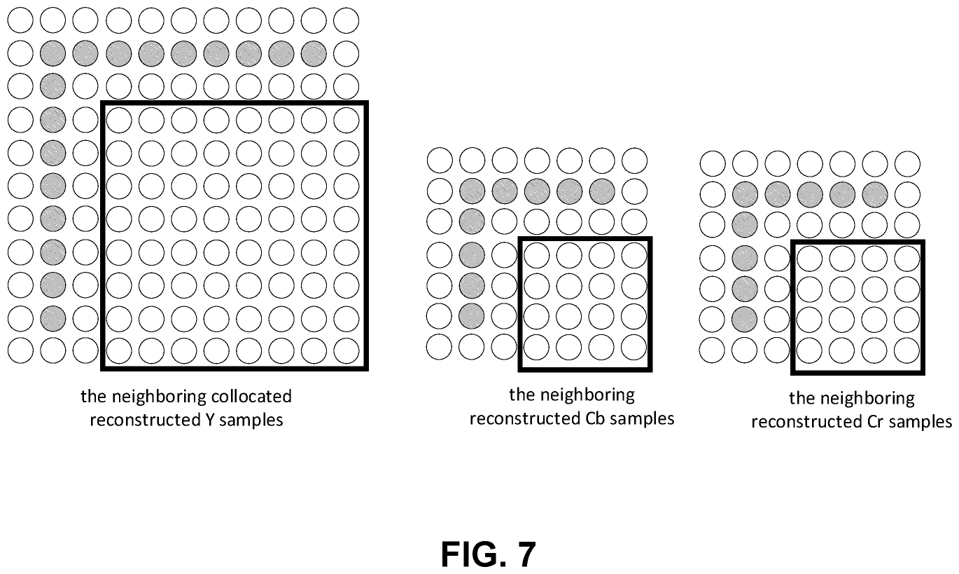

FIG. 9 illustrates an example of the location of the left and above samples and the sample of the current block involved in CCLM mode. FIG. 9 shows an example of locations of the samples used for the derivation of linear model parameters α and β.

CCLM may be extended by adding three multi-model LM (MMLM) modes. In each MMLM mode, the reconstructed neighboring samples may be classified into two classes using a threshold. The threshold may be the average of the luma reconstructed neighboring samples. The linear model of each class may be derived using the Least-Mean-Square (LMS) method. For the CCLM mode, the LMS method may be used to derive the linear model. A slope adjustment may be applied to CCLM and to MMLM prediction. The adjustment may involve tilting the linear function (e.g., which maps luma values to chroma values) with respect to a center point determined by the average luma value of the reference samples.

A CCLM slope adjustment may be implemented. CCLM may use a model with one or more (e.g., two) parameters to map luma values to chroma values. A slope parameter “a” and a bias parameter “b” may define a mapping, for example, in accordance with Eq. 5:

chromaVal=a*lumaVal+b Eq. 5

An adjustment “u” to the slope parameter may be signaled to update the model, for example, in accordance with Eq. 6:

chromaVal=a′*lumaVal+b′ Eq. 6

Updated slope parameters may be determined, for example, in accordance with Eq. 7a and 7b:

a′=a+u Eq. 7a

b′=b−u*yr Eq. 7b

The mapping function may be tilted or rotated around a point with luminance value yr, for example, based on the selection. An average of the reference luma samples used in the model creation may be used as yr, for example, to provide a (e.g., meaningful) modification to the model.

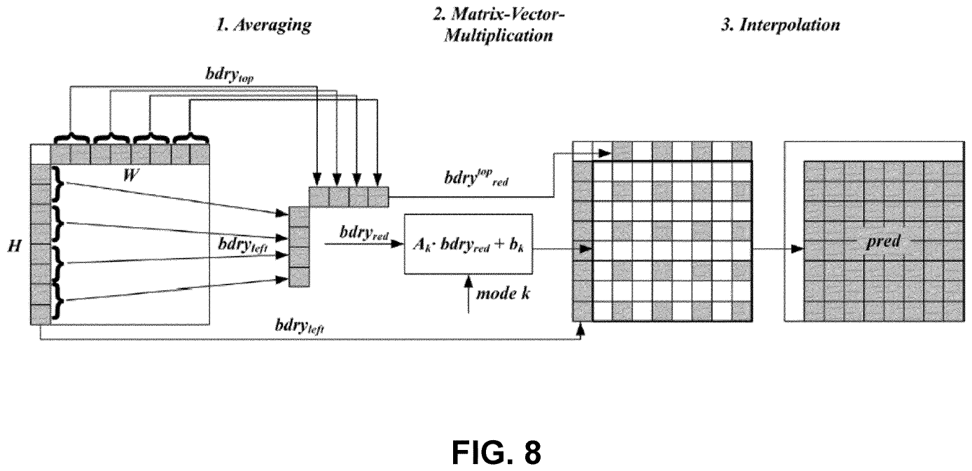

FIGS. 10A and 10B illustrate examples of the effect of the slope adjustment parameter “u”. FIG. 10A shows a model created for CCLM without updated slope parameters. FIG. 10B shows a model created for CCLM with updated slope parameters.

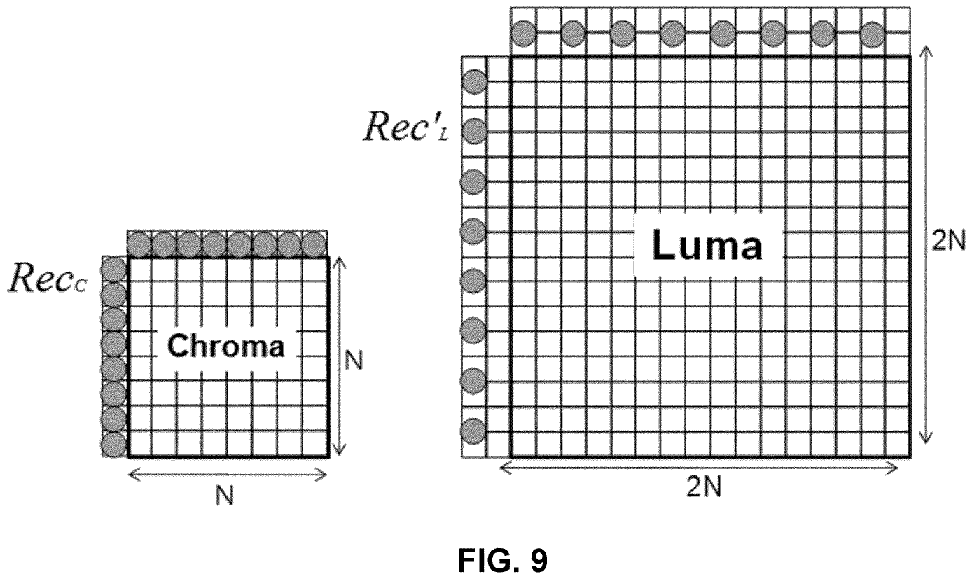

Feature(s) associated with a convolutional cross component mode (CCCM) are provided herein. The reconstructed luma samples to be used for chroma prediction may be filtered. A convolutional 7-tap filter may include a 5-tap plus sign shape spatial component, a nonlinear term, and a bias term, as illustrated in FIG. 11. The input to the spatial 5-tap component of the filter may include a center (C) luma sample (e.g., which may be collocated with the chroma sample to be predicted) and above/north (N), below/south(S), left/west (W) and right/east (E) neighbors, as shown.

The nonlinear term P may represent the power of two of the center luma sample C and scaled to the sample value range of the content:

P=(C*C+midVal)>>bitDepth Eq. 8

For 10-bit content, P may be calculated as:

P=(C*C+512)>>10 Eq. 9

The bias term B may represent a scalar offset between the input and output (e.g., similarly to the offset term in CCLM) and may be set to a middle chroma value (e.g., 512 for 10-bit content).

The output of the filter may be calculated as a convolution between the filter coefficients cᵢ and the input values and clipped to the range of valid chroma samples, as shown in Eq. 10:

predChromaVal=c₀C+c₁N+c₂S+c₃E+c₄W+c₅P+c₆B Eq. 10

Intra block copy (IBC) may improve the coding efficiency of screen content materials. IBC mode may be a block level coding mode. Block matching (BM) may be performed at the encoder to find the optimal block vector (or motion vector) for a CU (e.g., each CU). A block vector may be used to indicate a displacement from the current block to a reference block (e.g., which is already reconstructed inside the current picture). The luma block vector of an IBC-coded CU may be in integer precision. The chroma block vector may round to integer precision. When combined with AMVR, the IBC mode can switch between 1-pel and 4-pel motion vector precisions. An IBC-coded CU may be treated as the third prediction mode (e.g., other than intra- or inter prediction modes). The IBC mode may be applicable to the CUs with both width and height smaller than or equal to 64 luma samples.

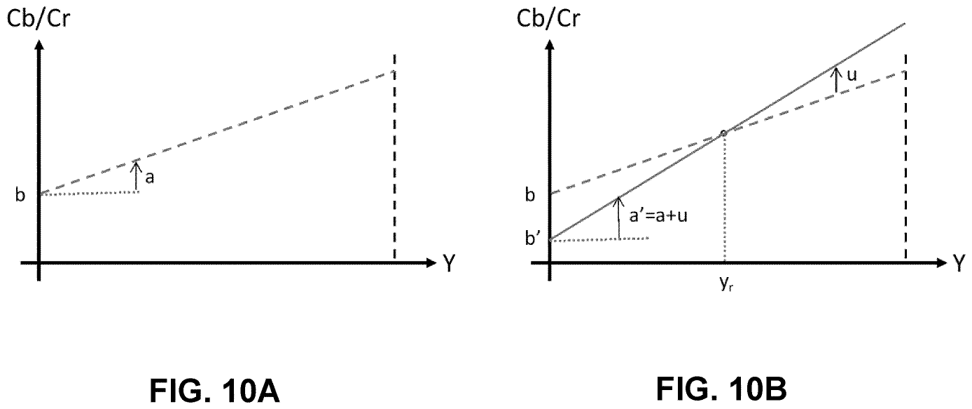

The reference area for IBC may be extended (e.g., to two CTU rows above). FIG. 12 illustrates the reference area for coding a coding tree unit (CTU) (m,n). FIG. 12 illustrates an example reference area for IBC when CTU (m,n) is coded. The block labeled “m,n” denotes the current CTU; other shaded blocks denote the reference area; and the white blocks denote an invalid reference area. For CTU (m,n) to be coded, the reference area may include CTUs with index (m−2,n−2) . . . (W,n−2),(0,n−1) . . . (W,n−1),(0,n) . . . (m,n), where W denotes a maximum horizontal index within the current tile, slice, or picture. When the CTU size is 256, the reference area may be limited to one CTU row above. This may ensure that, for CTU size being 128 or 256, IBC does not use extra memory. The per-sample block vector search (sometimes referred to as local search) range may be limited to [−(C<<1), C>>2] horizontally and [−C, C >>2] vertically to adapt to the reference area extension, where C denotes the CTU size.

Examples of intra template matching prediction (IntraTMP) are provided herein. IntraTMP is an intra prediction mode that can copy the best prediction block from the reconstructed part of the current frame, whose L-shaped template matches the current template. For a predefined search range, the encoder can search for the most similar template to the current template in a reconstructed part of the current frame. For a predefined search range, the encoder can use the corresponding block as a prediction block. The encoder can signal the usage of this mode, and the same prediction operation can be performed at the decoder side.

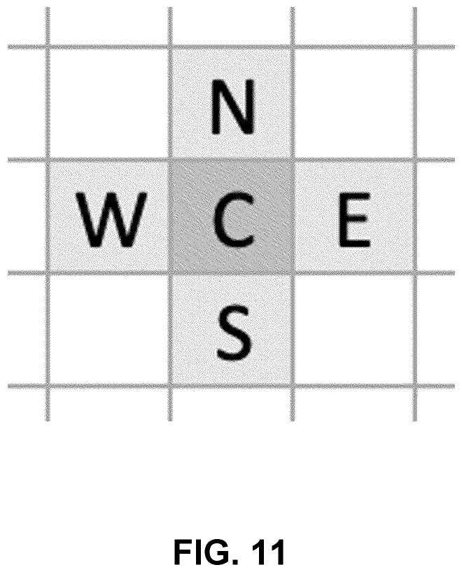

FIG. 13 illustrates an example of an intra template matching search area. The prediction signal can be generated by matching the L-shaped causal neighbor of the current block with another block in a predefined search area in FIG. 13, including:
R1: current CTU
R2: top-left CTU
R3: above CTU
R4: left CTU

The sum of absolute differences (SAD) can be used as a cost function. Within regions (e.g., within each region), the decoder may search for the template that has the least SAD with respect to the current one and use its corresponding block as a prediction block. The dimensions of the regions (SearchRange_w, SearchRange_h) may be set proportional to the block dimension (BlkW, BlkH) to have a fixed number of SAD comparisons per pixel. That is:

SearchRange_w=a*BlkW Eq. 11

SearchRange_h=a*BlkH Eq. 12

where ‘α’ is a constant that controls the gain/complexity trade-off. For example, ‘α’ may be equal to 5.

The intra template matching tool may be enabled for CUs with size less than or equal to 64 in width and height. This maximum CU size for intra template matching may be configurable. The intra template matching prediction mode may be signaled at the CU level through a dedicated flag. The intra template matching prediction mode may be signaled at CU level through a dedicated flag if DIMD is not enabled (e.g., DIMD=0). Although intra template matching examples are described herein, examples herein may also be applied for inter template matching.

Palette mode may be used to encode/decode a coding block. In some examples, palette mode may be used for screen content coding in the chroma formats supported in a 4:4:4 profile (that is, 4:4:4 4:2:0, 4:2:2 and monochrome). If palette mode is enabled, a flag may be transmitted at the CU level if the CU size is smaller than or equal to 64×64, and the amount of samples in the CU is greater than 16 to indicate whether palette mode is used. Applying palette mode on small CUs may introduce insignificant coding gain and bring extra complexity on the small blocks. Palette mode may be disabled for CUs that are smaller than or equal to 16 samples. A palette coded CU may be treated as a prediction mode (e.g., separate from intra prediction, inter prediction, and IBC mode).

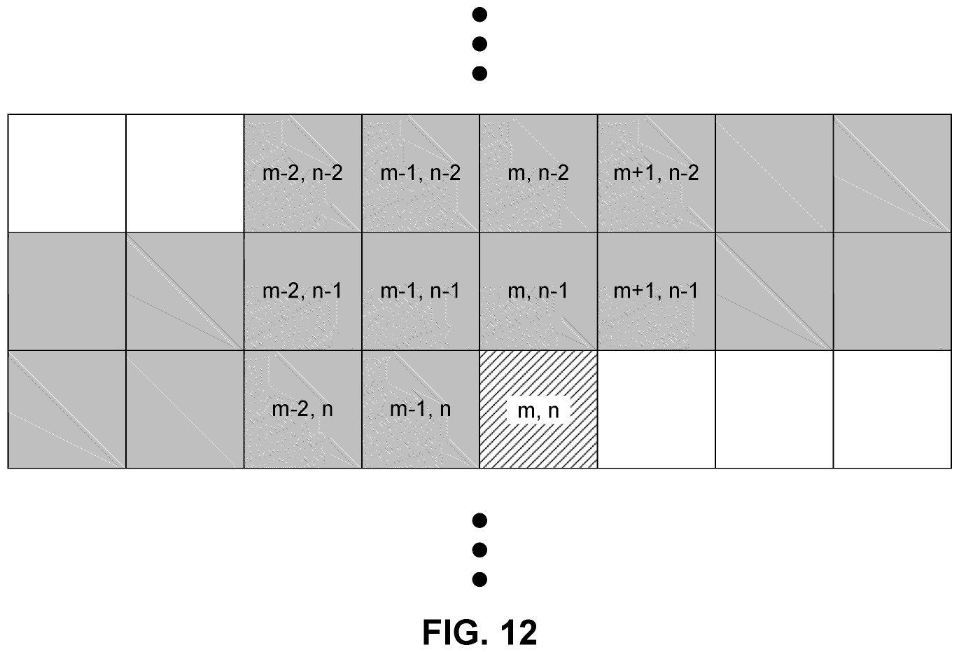

FIG. 14 illustrates an example of palette mode coding (e.g., with a palette size four). If palette mode is utilized, the sample values in the CU may be represented by a set of representative color values. The set may be referred to as the palette. For positions with sample values close to the palette colors, a palette index may be signaled. A sample that is outside the palette may be specified (e.g., by signaling an escape symbol). For samples within the CU that are coded using the escape symbol, their component values may be signaled (e.g., directly) using quantized component values. The quantized escape symbol may be binarized (e.g., with a fifth order Exp-Golomb binarization process (EG5).

A combined intra inter prediction (CIIP) mode may be used to code a block. In CIIP mode, the prediction samples may be generated by weighting an inter prediction signal predicted using a CIIP template matching (CIIP-TM) merge candidate and an intra prediction signal predicted using TIMD derived intra prediction mode. CIIP mode may be applied (e.g., only applied) to coding blocks with an area less than or equal to 1024.

The TIMD derivation method may be used to derive the intra prediction mode in CIIP. Specifically, the intra prediction mode with the smallest SATD values in the TIMD mode list may be selected and mapped to one of the 67 directional intra prediction modes (e.g., regular intra prediction modes).

The weights (wᵢₙₜᵣₐ, wᵢₙₜₑᵣ) for the two tests may be modified if the derived intra prediction mode is an angular mode. For near-horizontal modes (e.g., 2<=angular mode index <34), the current block may be vertically divided. For near-vertical modes (e.g., 34<=angular mode index <=66), the current block may be horizontally divided.

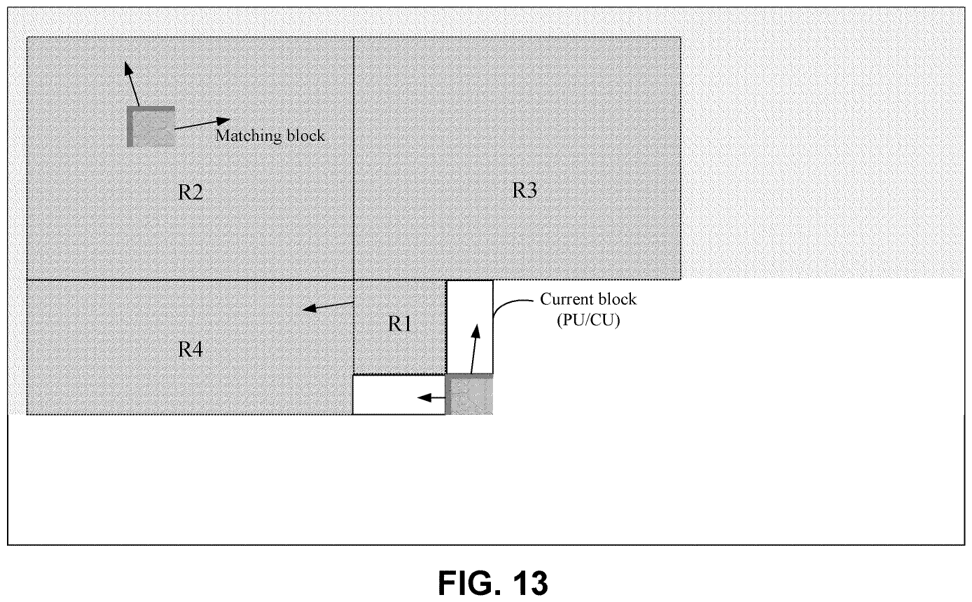

In some examples, a geometric partitioning mode (GPM) may be used with inter and intra prediction. In GPM with inter and intra prediction, the final prediction samples may be generated by weighting inter-predicted samples and intra-predicted samples for each GPM-separated region. The inter-predicted samples may be derived by inter-GPM whereas the intra-predicted samples may be derived by an intra prediction mode (IPM) candidate list and/or an index signaled from the encoder. The IPM candidate list size may be pre-defined as three. The available IPM candidates may be the parallel angular mode against the GPM block boundary (parallel mode), the perpendicular angular mode against the GPM block boundary (perpendicular mode), and the planar mode as shown FIGS. 15A-15C, respectively. FIG. 15D illustrates GPM with intra and intra prediction. The GPM with intra and intra prediction may be restricted (e.g., to reduce the signaling overhead for IPMs and/or avoid an increase in the size of the intra prediction circuit on the hardware decoder). A direct motion vector and IPM storage on the GPM-blending area may be introduced (e.g., to further improve the coding performance).

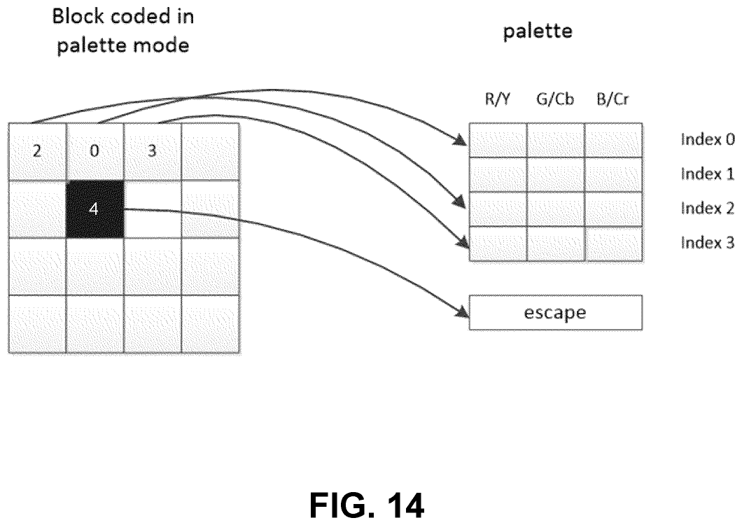

In DIMD and neighboring mode based IPM derivation, the parallel mode may be registered (e.g., first). If the same IPM candidate is not in the list, a maximum of two IPM candidates derived from the DIMD method and/or the neighboring blocks may be registered. As for the neighboring mode derivation, there may be five positions for available neighboring blocks (e.g., at most). The positions may be restricted by the angle of the GPM block boundary (e.g., as shown in FIG. 16), which may be used for GPM with template matching (GPM-TM). In FIG. 16, A and L may denote the above and left side of the prediction block, respectively.

In some examples, GPM-intra may be combined with GPM with merge with motion vector difference (GPM-MMVD). TIMD may be used on IPM candidates of GPM-intra (e.g., to further improve the coding performance). The parallel mode may be registered first. The IPM candidates of TIMD, DIMD, and neighboring blocks may be subsequently registered.

A low frequency non-separable transform (LFNST) may be performed. A forward LFNST may be applied to a top-left low frequency region, which may be called a region-of-interest (ROI). If LFNST is applied, primary-transformed coefficients that exist in the region outside of the ROI may be zeroed out.

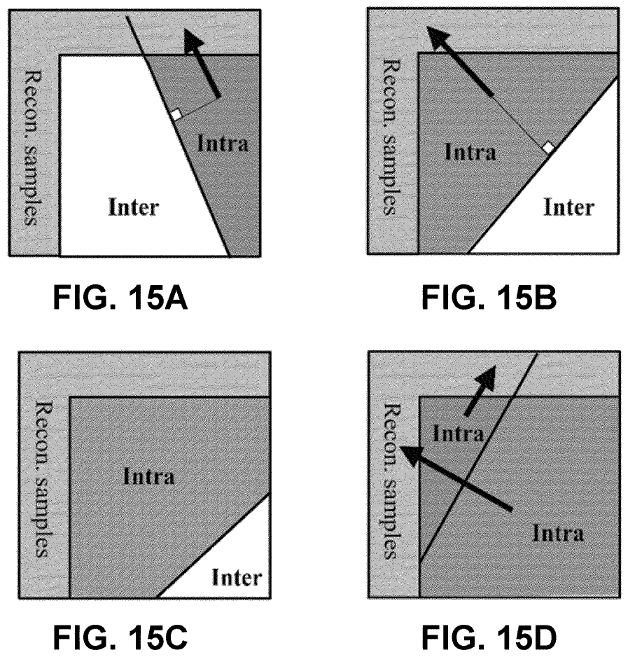

FIG. 17 illustrates the ROI for LFNST16. The ROI for LFNST 16 includes six 4×4 sub-blocks (e.g., which may be consecutive in scan order). The number of input samples may be 96. In this case, the transform matrix for forward LFNST16 can be Rx96. 32 coefficients (two 4×4 sub-blocks) may be generated from forward LFNST16 (e.g., if the value of R is chosen to be 32). The coefficients may be placed following a coefficient scan order.

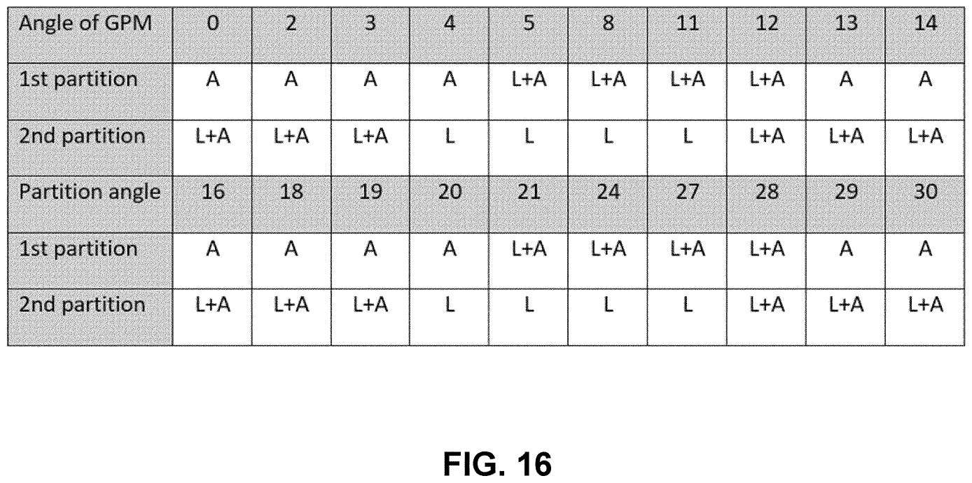

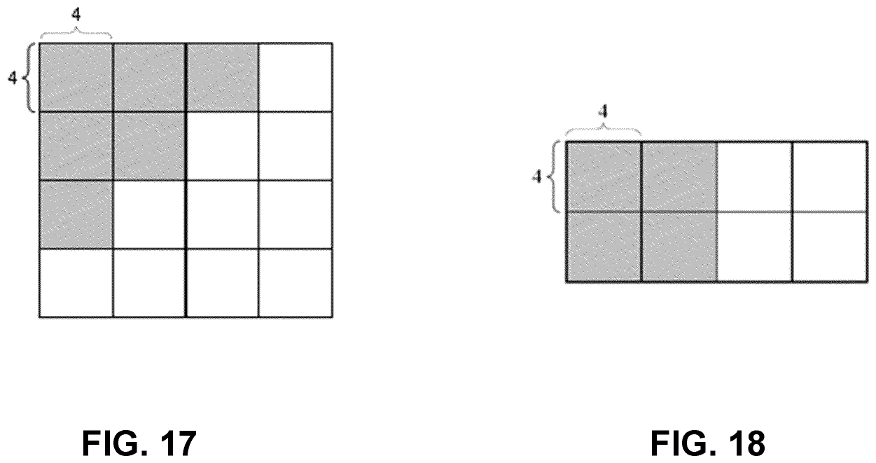

FIG. 18 illustrates the ROI for LFNST8. The forward LFNST8 matrix may be Rx64. The value of R may be 32. The generated coefficients may be located in the same manner as with LFNST 16. FIG. 19 illustrates an example mapping from intra prediction modes to LFNST set indices.

Multiple transform selection (MTS) may be used. For MTS, DST7 and DST8 (e.g., only DST7 and DCT8) transform kernels may be utilized. DST7 and DST8 transform kernels may be used for intra and inter coding.

Other primary transforms (e.g., including DCT5, DST4, DST1), and/or the identity transform (IDT) may be employed. The MTS set may be made dependent of the TU size and/or intra mode information. 16 different TU sizes may be considered. For each TU size, five different classes may be considered depending on intra-mode information. For each class, one, four, or six different transform pairs may be considered. The number of intra MTS candidates may be adaptively selected (e.g., between one, four, and six MTS candidates). The number of intra MTS candidates may depend on the sum of the absolute value of transform coefficients. The sum may be compared to one or more thresholds (e.g., two fixed thresholds) to determine the total number of allowed MTS candidates. For example:

1candidate:sum<=th0Eq.13

4candidates:th0<sum<=th1 Eq.14

6candidates:sum>th1 Eq.15

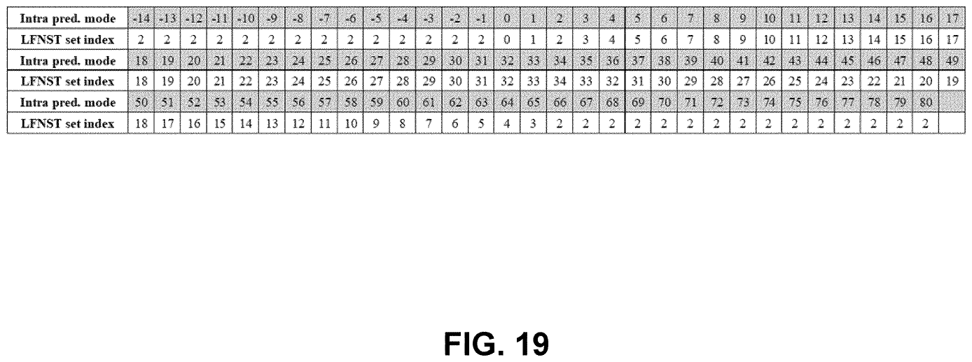

Intra mode propagation may be performed. For CU's not coded in intra prediction, the intra mode of the reference CU may be considered as the same intra mode as the current CU. This mode may be used when constructing the most probable mode (MPM) list of other blocks. MPM may be generated using a method. In the method, the first entry in the MPM list may be the planar mode. The remaining entries may include the intra modes of the left (L), above (A), below-left (BL), above-right (AR), and above-left (AL) neighboring blocks (e.g., as shown in FIG. 20), the directional modes with added offset from the first two available directional modes of neighboring blocks, and/or the default modes.

If any of the neighboring blocks is inter coded, the block's intra mode may be obtained from the reference block (or its reference if it is inter coded as well). A buffer of intra modes for position (e.g., with resolution of minimum CU size (4×4) may be generated. Upon coding a CU, the buffer may be filled in with an intra mode or reference intra mode (e.g., if inter coded). This process may be referred to as intra mode propagation. MIP, IntraTMP, and/or palette mode may be propagated as planar mode. The GPM mode with intra-inter mode may generate MPM with three entries (e.g., similar to MPM list generation).

The intra mode may provide useful information about the statistics of the current block. The intra mode may provide information about the directionality of the block. This information may be used to design a transform (e.g., the best transform) in MTS and/or LFSNT. LFNST may be a transform learned by clustering the residual signals according to their intra modes. The intra mode may be used to construct the MPM list. The intra mode may be used for GPM MPM.

In some examples, when coding a block in a non-directional intra prediction mode (e.g., inter prediction mode, IBC mode, IntraTMP mode, MIP, palette mode, cross component prediction mode, etc.), intra mode-dependent tools may be deactivated. For example, LFNST may be deactivated based on a block being coded in non-directional intra prediction mode (e.g., because LFNST is directional mode-dependent). MIP may be used with LFNST if planar mode is considered. In some examples, intra-dependent tools may use an equivalent mode. An equivalent mode (e.g., using DIMD process) may be used for LFNST kernel selection, where a coding gain is provided.

An equivalent mode (e.g., a directional intra prediction mode) for a block employing a non-directional intra prediction mode (e.g., a CU not employing regular intra coding) may be derived. For example, the directional intra prediction mode may be derived using TIMD and/or DIMD process. The equivalent mode may be used to select a MTS/LFSNT kernel and/or an intra mode propagation process.

In some examples, a video decoding device may determine that a current block is coded in a non-directional intra prediction mode. A directional intra prediction mode (e.g., that indicates a derived intra prediction direction) that corresponds to the non-directional intra prediction mode may be derived. A video decoding device may decode the current block based at least in part on the derived directional intra prediction mode.

A prediction block of the current block may be obtained using the non-directional intra prediction mode. In some examples, the directional intra prediction mode that corresponds to the non-directional intra prediction mode may be derived based on the prediction block. In some examples, reconstructed samples (e.g., a plurality of reconstructed samples) in the prediction block may be obtained. The directional intra prediction mode may be derived based on the reconstructed samples in the prediction block and reconstructed neighboring samples (e.g., a plurality of reconstructed neighboring samples) of the current block.

The directional intra prediction mode may be derived based on a histogram of gradients associated with reconstructed pixels neighboring the current block (e.g., the directional intra prediction mode may be derived by applying a DIMD process to a reconstructed template of the current block, for example, a template, a prediction block of the current block obtained using the non-directional intra prediction mode, or a reconstructed template inside the prediction block). For example, a plurality of samples in the prediction block may be obtained. A directionality of the prediction block may be determined.

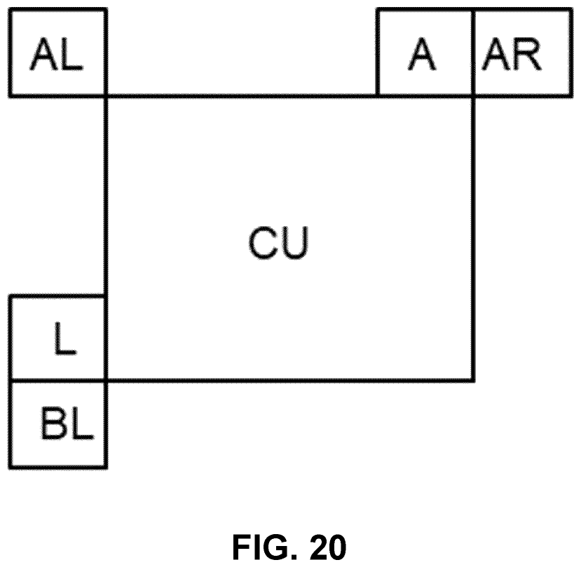

FIG. 21 illustrates a process for deriving an equivalent mode. For example, a DIMD process may be used to derive an equivalent mode (e.g., the directional intra prediction mode that corresponds to the non-directional intra prediction mode). An equivalent directional intra prediction mode for MIP may be generated during MIP prediction process (e.g., as illustrated in FIG. 21). In some example, DIMD may be applied to the reconstructed template around the current block. In some examples, the DIMD process may be applied to a prediction block (e.g., the prediction signal). For example, the DIMD process may be used to find the directionality of the prediction block generated by MIP process. For example, the directionality of the prediction block may be determined based on the plurality of samples in the prediction block. The intra prediction mode may be derived based on the determined directionality of the prediction block.

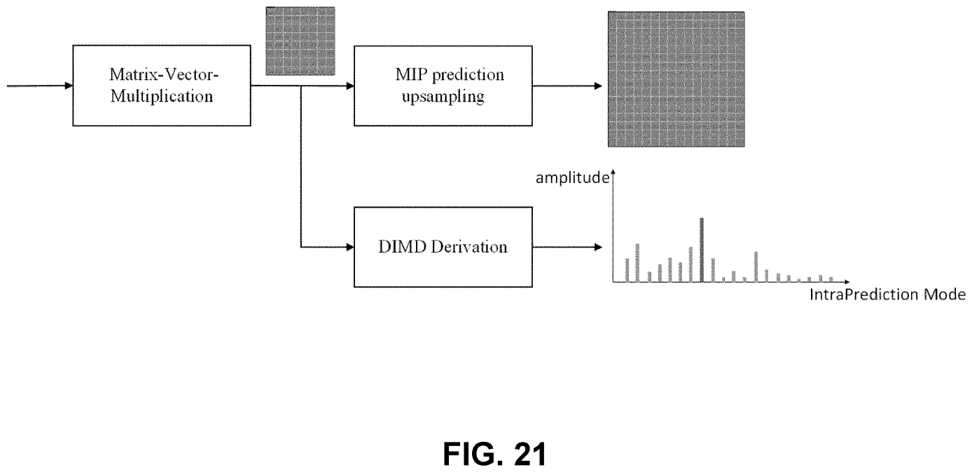

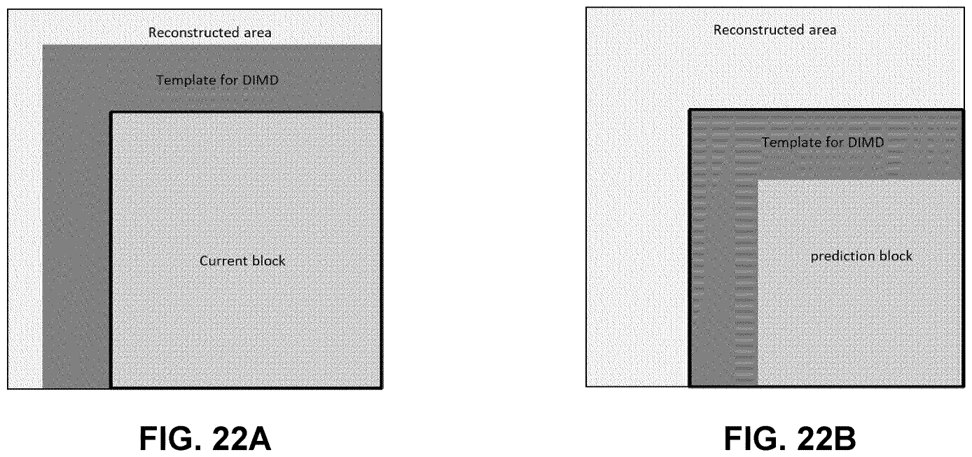

FIG. 22A illustrates an example DIMD process, where the template around the current block to be coded is used. FIG. 22B illustrates a process for deriving an MIP equivalent mode, where the template is a part of the prediction block (e.g., before up-sampling).

In some examples, the DIMD process may be used to analyze the prediction signal generated from inter prediction, IBC, CCLM/MMLM/CCCM, and/or IntraTMP. In some examples, the prediction unit (e.g., the entire prediction unit) may be analyzed to derive the equivalent directional intra prediction mode (e.g., instead of using a template inside the prediction unit). In some examples, a default DIMD process can be used as the equivalent directional intra prediction mode. This may be used for palette mode (e.g., because a prediction signal may not be generated with palette mode).

In some examples, the directional intra prediction mode may be derived by testing a plurality of candidate directional intra prediction modes on reconstructed pixels neighboring the current block; and selecting the directional intra prediction mode from the plurality of candidate directional intra prediction modes based on the testing. For example, a template-based intra mode derivation (TIMD) process may be applied to at least one of a reconstructed template of the current block, a prediction block of the current block obtained using the non-directional intra prediction mode, or a reconstructed template inside the prediction block.

For example, a TIMD process may be used to derive an equivalent directional intra prediction mode (e.g., the directional intra prediction mode that corresponds to the non-directional intra prediction mode). TIMD may be applied with the template surrounding the current block (e.g., in the same or similar manner as for DIMD). For example, the TIMD may be applied with the template surrounding the current block using a template inside the prediction block. For example, the TIMD may be applied with the template surrounding the current block using the whole prediction block.

For example, a prediction block of the current block may be obtained using the non-directional intra prediction mode. In some examples, reconstructed samples (e.g., a plurality of reconstructed samples) in the prediction block may be obtained. In some examples, probable prediction modes (e.g., a plurality of probable prediction modes) may be obtained. The predictions (e.g., a plurality of predictions) of the reconstructed samples in the prediction block may be computed. For example, the predictions of the reconstructed samples in the prediction block may be computed based on the probable prediction modes. Prediction errors (e.g., a plurality of prediction errors) may be computed. For example, the prediction errors may be computed based on the reconstructed samples in the prediction block and the corresponding predictions. The prediction errors may correspond to the probable prediction modes. The directional intra prediction mode may be selected (e.g., from the probable prediction modes) based on the prediction errors. In some examples, the directional intra prediction mode may be selected based on a determination that the prediction error that corresponds to the directional intra prediction mode is the smallest among the prediction errors.

In some examples, planar or DC mode may be used as the equivalent directional intra prediction mode. For example, MIP and IntraTMP may be considered as planar mode in LFNST kernel selection. In some examples, LFNST may be activated for directional inter prediction mode(s) and IBC mode.

In some examples, a history-based intra prediction mode (HIPM) may be used as the equivalent directional intra prediction mode. The history-based intra prediction mode may be used as an equivalent directional intra prediction mode for a CU employing a non-directional intra prediction mode (e.g., a CU that is not employing regular intra coding). In examples, the derivation process may be similar to history-based MVP (HMVP) merge candidates. The derived directional intra prediction mode (e.g., of a previously regular intra-coded block) may be stored in a table. The derived directional intra prediction mode may be used to generate an MPM list for a neighboring prediction block. The table with multiple HIPM candidates may be used as an equivalent directional intra prediction mode for the current CU. The table with multiple HIPM candidates may be maintained during the encoding and/or decoding process. The table may be reset (e.g., emptied) when a new CTU row is encountered. If there is a CU coded with a directional intra prediction mode (e.g., a regular intra-coded CU), the associated directional intra prediction mode may be added to the last entry of the table (e.g., as a new HIPM candidate).

The HIPM table size S may be set to a value M (e.g., indicating up to M−1 HIPM candidates may be added to the table). Two options may be considered when inserting a new directional intra prediction mode candidate to the table. For example, in a first option, the new HIPM may be moved to the last entry of the table. In this example, the HIPM candidates afterwards (e.g., all HIPM candidates afterwards) may be moved forward. In this example, the HIPM candidate in the last entry of the table may be considered to be “nearest/closest” and may be used as the equivalent directional intra prediction mode.

For example, in a second option, the appearance of the existing HIPM in the table may be counted. It may be determined whether an identical HIPM exists in the table. If found, the count of the identical HIPM may be added. In this case, the current HIPM table may be reordered. For example, if the HIPM candidate appearance count is higher than the last entry of the current HIPM table, the HIPM candidate may move to the last entry of the table. In this case, the HIPM candidate in the last entry of the table may be used as an equivalent directional intra prediction mode (e.g., because it is used frequently).

LFNST may be performed based on an equivalent directional intra prediction mode. For example, an LFNST transform set may be determined/selected based on the derived directional intra prediction mode. The equivalent directional intra prediction mode may be derived as described herein. The current block may be encoded and/or decoded based on the LFNST transform set. For example, a transform or inverse transform may be performed on a residual of the current block based on the LFNST transform set.

The LFNST for inter-coded CUs and IBC mode may be activated. Equivalent directional intra prediction mode derivation may be used for LFNST kernel selection. LFNST for cross-component prediction/IntraTMP may be activated (e.g., with equivalent mode derivation for LFNST kernel selection, instead of assuming planar mode).

In examples, MTS may be performed using an equivalent directional intra prediction mode. For example, an MTS transform set may be determined based on the derived directional intra prediction mode. The current block may be encoded and/or decoded based on the MTS transform set. For example, a transform or inverse transform may be performed on a residual of the current block based on the MTS transform set. The MTS IBC and IntraTMP mode may be activated (e.g., with equivalent mode derivation for LFNST kernel selection). In some examples, the MTS for chroma part may be activated (e.g., with cross-component prediction with equivalent mode derivation for LFNST kernel selection, instead of assuming planar mode). MTS kernel selection may be used for inter CUs (e.g., with equivalent directional intra prediction mode derivation for kernel selection).

In some examples (e.g., for inter-CUs), an MTS index may be coded independently from the directional intra prediction mode. In some examples, a table to map the MTS index to kernel may be (pre) defined.

Specific considerations for TU split may be provided. In some examples, TU splitting may be allowed. The CU may be split into multiple TUs. For example, the CU may be split into multiple TUs using a residual quad tree (RQT). The RQT may be removed in some examples.

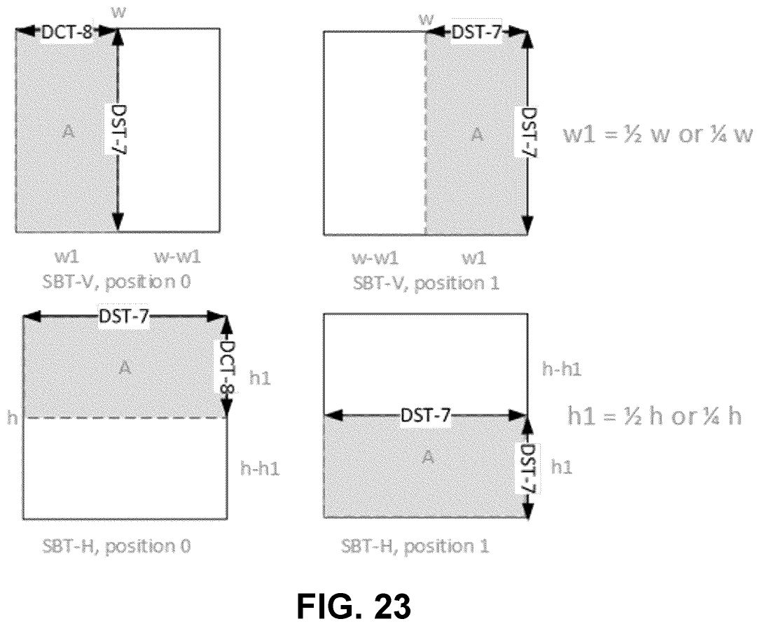

A subblock transform (SBT) may be similar to the RQT. The SBT may be used on inter-coded CUs. Using SBT, a CU may be split into two parts (e.g., as illustrated in FIG. 23). One of the parts may be zeroes out. The other part may be transformed using a (pre) defined transform set.

In cases where TUs are smaller than CUs (e.g., like in SBT), the equivalent directional intra prediction mode derivation may be carried out on every TU. This may yield N equivalent modes for N sub-partitioning. This may allow proper selection of MTS/LFNST kernel and/or may provide better propagation of the equivalent directional intra prediction mode. In SBT specifically, because a (e.g., one) partition is zeroed out, the equivalent directional intra prediction mode for that partition may not be determined.

In some examples, the equivalent directional intra prediction mode may be propagated. The equivalent directional intra prediction mode may be derived (e.g., as described herein) when the intra mode propagation is used. For example, if a non-directional intra prediction mode (e.g., IBC, inter, cross-component prediction, IntraTMP, palette mode) is used, the equivalent directional intra prediction mode may be used to fill the intra-mode buffer.

Specific considerations for CIIP and/or GPM mode may be provided. For example, CIIP may be used to derive a directional intra prediction mode for an intra part when CIIP is used. For example, a directional intra prediction mode may be derived when GPM Intra-Inter is used. An equivalent directional intra prediction mode may not be derived for the CIIP and/or GPM modes. The intra mode of the intra part of CIIP and/or GPM modes may be used for LFNST/MTS kernel selection and intra-mode propagation.

An video encoding device (e.g., encoder) may perform the same or similar actions as those described above. For example, the encoder may identify a non-directional intra prediction mode for encoding a current block. The encoder may derive a directional intra prediction mode (e.g., that comprises a derived intra prediction direction) that corresponds to the non-directional intra prediction mode. The encoder may encode the current block based at least in part on the derived directional intra prediction mode.

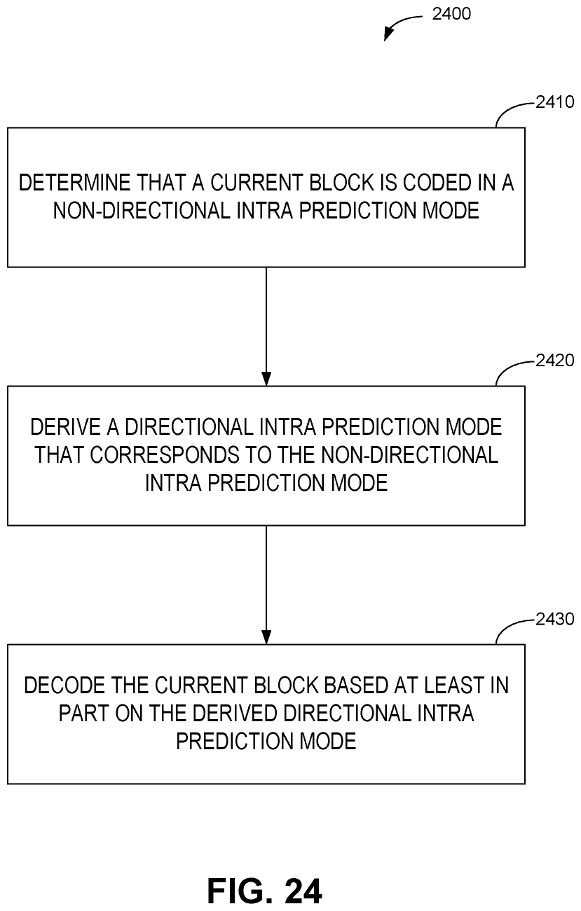

FIG. 24 illustrates an example flow chart 2400 for decoding a current block. At 2410, it may be determined that a current block is coded in a non-directional intra prediction mode. At 2420, a directional intra prediction mode that corresponds to the non-directional intra prediction mode may be derived. At 2430, the current block may be decoded based at least in part on the derived directional intra prediction mode.

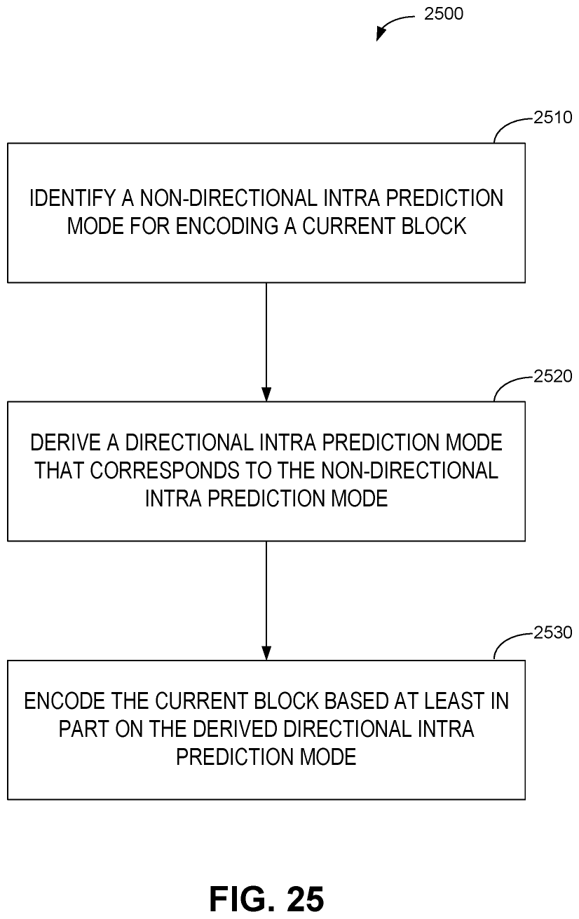

FIG. 25 illustrates an example flow chart 2500 for encoding a current block. At 2510, a non-directional intra prediction mode for encoding a current block may be identified. At 2520, a directional intra prediction mode that corresponds to the non-directional intra prediction mode may be derived. At 2530, the current block may be encoded based at least in part on the derived directional intra prediction mode.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-46. (canceled)

47. A device for video decoding comprising:
a processor configured to:
determine that a current block is coded in a non-directional intra prediction mode;
derive a directional intra prediction mode that corresponds to the non-directional intra prediction mode, wherein the derived directional intra prediction mode is a planar prediction mode, a direct current (DC) prediction mode, or an angular prediction mode; and
decode the current block based at least in part on the derived directional intra prediction mode.

48. The device of claim 47, wherein the non-directional intra prediction mode is associated with a plurality of intra prediction directions.

49. device of claim 47, wherein the processor is further configured to:
obtain a prediction block of the current block using the non-directional intra prediction mode; and
obtain a plurality of reconstructed samples in the prediction block, wherein the directional intra prediction mode is derived based on the plurality of reconstructed samples in the prediction block and a plurality of reconstructed neighboring samples of the current block.

50. The device of claim 47, wherein the processor is further configured to:
store the derived directional intra prediction mode; and
use the derived directional intra prediction mode to generate a most probable mode (MPM) list for a neighboring prediction block.

51. The device of claim 47, wherein the processor is further configured to determine a low-frequency non-separable transform (LFNST) transform set based on the derived directional intra prediction mode, and wherein the current block is decoded based on the LFNST transform set.

52. The device of claim 47, wherein the processor is further configured to determine a multi-transform selection (MTS) transform set based on the derived directional intra prediction mode, and wherein the current block is decoded based on the MTS transform set.

53. The device of claim 47, wherein the directional intra prediction mode is derived based on a histogram of gradients associated with reconstructed pixels neighboring the current block.

54. The device of claim 47, wherein the processor being configured to derive the directional intra prediction mode comprises the processor being configured to:
test a plurality of candidate directional intra prediction modes on reconstructed pixels neighboring the current block; and
select the directional intra prediction mode from the plurality of candidate directional intra prediction modes based on the testing.

55. The device of claim 47, wherein the processor is further configured to:
obtain a prediction block of the current block using the non-directional intra prediction mode;
obtain a plurality of reconstructed samples in the prediction block;
obtain a plurality of probable prediction modes;
compute a plurality of predictions of the plurality of reconstructed samples in the prediction block based on the plurality of probable prediction modes;
compute, based on the plurality of reconstructed samples in the prediction block and the corresponding plurality of predictions, a plurality of prediction errors that correspond to the plurality of probable prediction modes; and
select, among the plurality of probable prediction modes, the directional intra prediction mode based on the plurality of prediction errors.

56. The device of claim 47, wherein the non-directional intra prediction mode comprises an inter prediction mode, a cross component prediction mode, a palette mode, an intra block copy (IBC) mode, or an intra template matching prediction (IntraTMP) mode.

57. A method comprising:
determining that a current block is coded in a non-directional intra prediction mode;
deriving a directional intra prediction mode that corresponds to the non-directional intra prediction mode, wherein the derived directional intra prediction mode is a planar prediction mode, a direct current (DC) prediction mode, or an angular prediction mode; and
decoding the current block based at least in part on the derived directional intra prediction mode.

58. The method of claim 57, wherein the non-directional intra prediction mode is associated with a plurality of intra prediction directions.

59. The method of claim 57, wherein the method further comprises:
obtaining a prediction block of the current block using the non-directional intra prediction mode; and
obtaining a plurality of reconstructed samples in the prediction block, wherein the directional intra prediction mode is derived based on the plurality of reconstructed samples in the prediction block and a plurality of reconstructed neighboring samples of the current block.

60. The method of claim 57, wherein the method further comprises:
storing the derived directional intra prediction mode; and
using the derived directional intra prediction mode to generate a most probable mode (MPM) list for a neighboring prediction block.

61. The method of claim 57, wherein the method further comprises determining a low-frequency non-separable transform (LFNST) transform set based on the derived directional intra prediction mode, and wherein the current block is decoded based on the LFNST transform set.

62. The method of claim 57, wherein the method further comprises determining a multi-transform selection (MTS) transform set based on the derived directional intra prediction mode, and wherein the current block is decoded based on the MTS transform set.

63. The method of claim 57, wherein the directional intra prediction mode is derived based on a histogram of gradients associated with reconstructed pixels neighboring the current block.

64. The method of claim 57, wherein deriving the directional intra prediction mode further comprises:
testing a plurality of candidate directional intra prediction modes on reconstructed pixels neighboring the current block; and
selecting the directional intra prediction mode from the plurality of candidate directional intra prediction modes based on the testing.

65. The method of claim 57, wherein the method further comprises:
obtaining a prediction block of the current block using the non-directional intra prediction mode;
obtaining a plurality of reconstructed samples in the prediction block;
obtaining a plurality of probable prediction modes;
computing a plurality of predictions of the plurality of reconstructed samples in the prediction block based on the plurality of probable prediction modes;
computing, based on the plurality of reconstructed samples in the prediction block and the corresponding plurality of predictions, a plurality of prediction errors that correspond to the plurality of probable prediction modes; and
selecting, among the plurality of probable prediction modes, the directional intra prediction mode based on the plurality of prediction errors.

66. The method of claim 57, wherein the non-directional intra prediction mode comprises an inter prediction mode, a cross component prediction mode, a palette mode, an intra block copy (IBC) mode, or an intra template matching prediction (IntraTMP) mode.
